(19) United States
(12) Patent Application Publication
(10) Pub. No.: US 2009/0138342 A1
(43) Pub. Date: May 28, 2009

(54) Method and system for providing an employee award using artificial intelligence

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, Lake Worth, FL (US)

(21) Appl. No.: 12/283,476

(22) Filed: Sep. 12, 2008

Related U.S. Application Data
(63) Continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 10/00; G06N 5/02; G06F 15/16

(52) U.S. Cl. 705/11; 705/1; 705/7; 706/47; 709/203

(57) ABSTRACT

A system for providing an incentive for an employee, including: an interface element for at least one specially programmed general-purpose computer; a memory unit for the at least one specially programmed general-purpose computer; and a processor for the at least one specially programmed general-purpose computer for: generating, using an artificial intelligence program (AIP) in the memory unit, an incentive for at least one employee of a first business entity to perform at least one desired operation; and transmitting, using the interface element, the incentive for display on a display device. In one embodiment, the desired operation includes presenting an upsell offer.

### CROSS-REFERENCE TO RELATED APPLICATIONS

This is a continuation-in-part patent application under 35 USC 120 of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for motivating employees to perform behaviors related to upsells and, more particularly, to methods and systems for providing compensation information to employees such as sales clerks, cashiers and call-center operators to motivate such employees to perform desired sales behaviors associated with upselling products (i.e., goods or services) to customers, using an artificial intelligence program.

### BACKGROUND OF THE INVENTION

Employers have found that the performance levels of salespeople and other employees can be enhanced by providing prompt recognition of employee performance and by paying sales commissions. By providing such recognition and commissions, employees can be motivated to perform desired behaviors that tend to benefit their employers by, for example, leading to the sale of more products. Generally, recognition and commission systems tend to be more effective in shaping employee performance where they are directly related to the employees' actions, and where the employees can easily determine the amounts of the commissions that they have earned.

Typical commission systems lose some of their motivational effect due to the time period that elapses between the time of an employee's behavior and the time the employee finds out what commission was earned. An employee may not find out what commission was earned until he sees the commission data in his weekly, semi-monthly or monthly paycheck. Thus, an employee may not receive any indication of what commission she earned until days or weeks after her behavior. This significant lapse of time weakens the tie between the employee's behavior and the commission since the employee may forget how he behaved during the preceding pay period, and may not understand how his behaviors during that period affected his earnings. The time between an employee's behavior and payment of his commission also prevents the employee from receiving the increased motivation associated with instant gratification.

Some commission systems lose some of their motivational effect due to their complex nature, which makes it difficult for employees to properly understand the relationship between their behaviors and the amounts of the commissions they earn. In establishing commission systems to properly motivate their employees, employers have provided monetary and non-monetary rewards and benefits on the basis of many performance metrics and combinations thereof. The calculation of commissions under many of these systems is so complex, however, that employees often fail to understand how their behaviors relate to specific commission amounts. This lack of understanding can be a significant concern for employers, since an employee is less likely to act in a desired manner if he does not understand the specific benefits of acting in that manner. This problem is accentuated in work settings in which the employees are relatively uneducated and have low mathematical skills. For example, the relatively low skill level of many employees in the quick-service restaurant industry has been a significant reason why that industry has not instituted commission-based compensation systems.

Another problem faced by employers in instituting commission systems is the difficulty of changing such systems once they have been established. When an employer modifies an existing commission system, the employees are forced to learn how the new system works, and possibly unlearn the working habits developed under the prior system. Some employees may become confused or exasperated when faced with a change in commission systems, leading to a lack of motivation. Such problems may be particularly acute in industries where employees traditionally have low morale and are unmotivated. Faced with such problems, employers typically do not modify their commission systems often. The difficulties associated with forcing employees to understand modified commission systems also make it difficult for employers to experiment with new commission systems in order to determine the optimum system.

Another problem with traditional commission systems involves the inability to provide incremental incentives (i.e., incentives paid relatively frequently in small increments, rather than being paid less often in a lump sum). Commissions have traditionally been paid to salesmen of large-ticket items, such as cars or appliances, upon the completion of each sale. The inability to provide incremental incentives has discouraged the use of commissions in industries where the typical transaction is relatively small (e.g., in the quick-service restaurant industry), and has discouraged the use of commissions to encourage employee behaviors providing only a small or indeterminate incremental value to employers (e.g., an employee greeting a customer). Also, known systems are not readily adaptable to different parameters related to operations of the employer.

Thus, there is a long-felt need to provide a system and a method to motivate desired employee behaviors that is relatively simple for the employee to understand, is dynamic, is incremental, and can be readily adapted to meet various and variable requirements of the employer.

### SUMMARY OF THE INVENTION

The invention broadly comprises a system for providing an incentive for an employee, including: an interface element for at least one specially programmed general-purpose computer; a memory unit for the at least one specially programmed general-purpose computer; and a processor for the at least one specially programmed general-purpose computer for: generating, using an artificial intelligence program (AIP) in the memory unit, an incentive for at least one employee of a first business entity to perform at least one desired operation; and transmitting, using the interface element, the incentive for display on a display device. In one embodiment, the desired operation includes presenting an upsell offer.

In one embodiment, the memory unit stores historical data regarding upsell offers, the historical data including acceptance rates of previous upsell offers; or financial considerations, with respect to the first business entity, of previous upsell offers and the processor is for generating the incentive using the historical data or for modifying, using the AIP and the historical data, the incentive. In another embodiment, the memory unit stores historical data regarding performance of the at least one employee, the historical data including previous compliance of the at least one employee with respect to presenting previous upsell offers; or financial considerations, with respect to the first business entity, of upsell offers previously available for presentation by the at least one employee, and the processor is for generating the incentive using the historical data or for modifying, using the AIP and the historical data, the incentive.

In one embodiment, the processor is for: determining, using the AIP, a presentation for the incentive, the presentation including a format for the display of the incentive or a time for displaying the incentive and the processor is for transmitting, using the interface element, data regarding the presentation for use by the display device. In another embodiment, the memory unit stores historical data regarding upsell offers, the historical data including acceptance rates of previous upsell offers; or financial considerations, with respect to the first business entity, of previous upsell offers and he processor is for determining the presentation using the historical data or for modifying, using the AIP and the historical data, the presentation of the incentive. In a further embodiment, the memory unit stores historical data regarding performance of the at least one employee, the historical data including previous compliance of the at least one employee with respect to presenting previous upsell offers; or financial considerations, with respect to the first business entity, of upsell offers previously available for presentation by the at least one employee and the processor is for determining the presentation using the historical data or for modifying, using the AIP and the historical data, the presentation.

In one embodiment, the processor is for: receiving, using the interface element, at least one rule from a wireless communications device or from a general-purpose computer associated with a second business entity; storing the at least one rule in the memory element; modifying the incentive or the presentation using the processor and the at least one rule; and transmitting, using the interface element, the modified incentive or presentation for display on the display device. In another embodiment, the first and second business entities are the same.

The invention also broadly comprises a method for providing an incentive for an employee.

It is a general object of the present invention to provide a system and a method to automatically and intelligently generate and modify an incentive for an employee to perform a desired operation.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing Figures, in which:

FIG. 1 is a flow chart illustrating an exemplary embodiment of a method for motivating an employee to perform a behavior related to an upsell by providing information about a compensation associated with the upsell to the employee (or other person such as the employee's manager) in accordance with the present invention;

FIG. 2A is a hardware block diagram showing an exemplary embodiment of a computer system used to implement the method illustrated in FIG. 1;

FIG. 2B is a hardware block diagram showing another exemplary embodiment of a computer system used to implement the method illustrated in FIG. 1;

FIG. 3 is a hardware block diagram showing an exemplary embodiment of the central computer shown in FIG. 2A or 2B, which includes several databases;

FIG. 4 is a table representing an embodiment of the compensation database shown in FIG. 3 for storing compensations associated with particular upsells, wherein the compensation database is populated by sample values for illustration only;

FIG. 5 is a table representing an embodiment of the employee database shown in FIG. 3 for storing information about employees, wherein the employee database is populated by sample values for illustration only;

FIG. 6 is a table representing an embodiment of the goal database shown in FIG. 3 for storing information about goals which can be earned by employees, wherein the goal database is populated by sample values for illustration only;

FIG. 7A is a flow chart showing another exemplary embodiment of a method for motivating an employee to perform a behavior related to an upsell which includes outputting compensation information to an employee for offering an upsell, and then providing the compensation to the employee if the upsell is offered correctly;

FIG. 7B is a flow chart showing another exemplary embodiment of a method for motivating an employee to perform a behavior related to an upsell which includes outputting a prompt corresponding to an upsell to an employee, and of also outputting an indication of a compensation to the employee for offering the upsell;

FIG. 7C is a flow chart showing another exemplary embodiment of a method for motivating an employee to perform a behavior related to an upsell which includes outputting information to an employee which describes a compensation for offering an upsell to a customer;

FIG. 8A is a flow chart showing another exemplary embodiment of a method for motivating an employee to perform a behavior related to an upsell which includes outputting compensation information to an employee for completing an upsell, and of then providing the compensation to the employee if the upsell is accepted;

FIG. 8B is a flow chart showing another exemplary embodiment of a method for motivating an employee to perform a behavior related to an upsell which includes outputting a prompt corresponding to an upsell to an employee, and of also outputting an indication of a compensation to the employee for completing the upsell;

FIG. 8C is a flow chart showing another exemplary embodiment of a method for motivating an employee to perform a behavior related to an upsell which includes outputting information describing a compensation offered to an employee for completing an upsell to a customer;

FIG. 9 is a flow chart showing another exemplary embodiment of a method for motivating an employee to perform a behavior related to an upsell which includes outputting compensation information relative to another employee;

FIG. 10 is a flow chart showing another exemplary embodiment of a method for motivating an employee to perform a behavior related to an upsell which includes outputting compensation information relative to a determined goal;

FIG. 11 is a flow chart showing another exemplary embodiment of a method for motivating an employee to perform a behavior related to an upsell which includes outputting compensation information that is personalized to an employee;

FIG. 12 is a flow chart showing another exemplary embodiment of a method for motivating an employee to perform a behavior related to an upsell which includes using feedback in determining a compensation for an employee;

FIG. 13 is a flow chart showing another exemplary embodiment of a method for motivating an employee to perform a behavior related to an upsell which includes using feedback in determining a compensation output strategy;

FIG. 14 is a flow chart showing an exemplary embodiment of a method for motivating an employee to not perform an undesired behavior related to an upsell which includes determining a penalty that may apply to an employee for performing an undesired behavior and also outputting information about the penalty to the employee;

FIG. 15 is a schematic block diagram of a present invention system for providing an employee award using a generic algorithm; and,

FIG. 16 is a flow chart of a present invention method for providing an employee award using a generic algorithm.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

According to one aspect of the invention, the disclosed methods and systems determine compensation information for motivating employees to perform particular behaviors, and communicate this compensation information to the employees in real-time (i.e., contemporaneously or nearly-contemporaneously) with their behavior. Since the behavior and compensation are closely tied, the motivation for employees can be more effective than the motivation provided by traditional compensation systems.

According to another aspect of the invention, the disclosed methods and systems provide compensation information to employees in a simple and straightforward manner that can be understood even by relatively unsophisticated and uneducated employees. Since the employees understand when and how they are being paid, the employees may be more motivated to perform as desired by their employers.

According to another aspect of the invention, by providing easy-to-understand compensation information to employees, the disclosed methods and systems allow employers to design more complex compensation systems than previously possible or practical. The easy-to-understand information allows employees to focus on performing their jobs rather than on remembering and understanding the intricacies of their compensation system. Instead, by performing desired behaviors (e.g., by offering upsells), employees receive real-time feedback in terms of compensation being earned. The real-time, easy-to-understand information provided to employees by the disclosed methods and systems allows employers to implement relatively complex compensation systems which provide a high level of both motivation and guidance to their employees, without necessarily requiring the attention of a manager or other human intervention.

According to another aspect of the invention, the disclosed methods and systems allow employers to dynamically change their compensation systems more often than with traditional systems. Since the compensation information is provided in simple and easy-to-understand terms, employers can change their compensation systems without needlessly confusing or exasperating their employees. Thus, employers can change their compensation systems weekly, daily or even on an hour-by-hour or sale-by-sale basis without adversely affecting their employees' motivation. This flexibility allows employers to guide their employees with increased precision and effectiveness, and even allows employers to experiment with new compensation systems (either manually or automatically) to determine the optimum system. The flexible compensation systems can also be tied to specific corporate objectives, such as the desire to sell aging products before their expiration dates, or to upsell particular products as part of promotional campaigns.

According to another aspect of the invention, the disclosed methods and systems implement a compensation system that employs incremental incentives. The use of incremental incentives allows the incentives to be tied even more closely to behavior since even individual behaviors can be compensated. Incremental incentives can also be used to motivate employees in a greater variety of industries than those which have traditionally used commissions. Further, incremental incentives may be more appealing to certain employees than the commissions offered by traditional commission systems since they provide more immediate gratification and recognition.

According to a further aspect of the invention, the disclosed methods and systems can be used to motivate even employees who are not primarily employed as salesmen to behave in particular manners that will tend to increase total sales. For example, commonly-owned and co-pending U.S. Pat. No. 6,119,099, entitled “Method and System for Processing Supplementary Product Sales at a Point-of-Sale Terminal”, issued on Sep. 12, 2000, and incorporated herein by reference, discloses a method and system wherein an employee can offer to upsell a product to a customer along with a purchase. Applicants have discovered that an employee's success in causing a customer to accept an upsell depends in large part on the employee's behavior in offering the upsell, and the rate of customer acceptance can be low if the employee does not perform the desired behaviors (e.g., the acceptance rate may be zero if the upsell is not offered). The disclosed methods and systems can motivate sales clerks, cashiers and call-center operators to offer and complete such upsells to their customers.

As used herein, an “upsell” is a product (i.e., a good or service) offered along with a purchase being made by a customer at a price referred to as an “upsell price”. A number of types of upsells are possible, including (i) an upgrade from a first product to a second product different from the first product, which may include an upgrade in the size, quantity, amount or quality of the first product, (ii) an additional product, (iii) a voucher which is redeemable for a product or a discount thereon, and (iv) an entry in a contest, lottery or other game. Various other types of upsells may also be used without departing from the scope and spirit of the invention. A “dynamically-priced upsell” refers to an upsell offered at a price which is determined at the time of a transaction. Further information about “upsells” and “dynamically-priced upsells” is provided in commonly-owned and co-pending U.S. Pat. No. 6,119,099, entitled “Method and System for Processing Supplementary Product Sales at a Point-of-Sale Terminal”, issued on Sep. 12, 2000, and incorporated herein by reference in its entirety.

Also as used herein, an “employee” is an individual who is used by an employer to perform a job or task, and is typically paid by the employer. The employee may operate a point-of-sale (POS) terminal, a telephone or a computer station in a customer-service center, or may otherwise interact directly or indirectly with customers. For example, an employee may be a sales clerk, a cashier or a call-center operator. The term “employee” as used herein may include individuals classified as “independent contractors” in other legal contexts. An “employer” is an individual, business or other entity that utilizes one or more employees to perform a job, and is preferably an employer that desires to use a compensation system to create incentives for its employees to behave in certain manners when dealing with its customers. In some cases, employees may be managed by at least one “manager”, who has the duty of managing the employees (e.g., setting their hours and duties, and monitoring their job performance), and may in some instances provide input to the compensation system for or on behalf of the employees. A “customer” is an individual, acting on his own behalf or on behalf of another, who purchases one or more products.

Also as used herein, a “prompt” is a message output to an employee, indicating that he should or should not perform, or continue or discontinue to perform, a particular behavior. The prompted behavior may include a behavior associated with offering an upsell to a customer, or completing a transaction including an upsell. The prompted behavior may also be a non-transaction behavior (e.g., greeting a customer at the front of a store). A “behavior” is at least one action or a result of at least one action by an individual, and may be performed by an employee and described in a prompt. A “compensation” is a form of payment or reward that may be provided to an employee. Compensation may be earned as part of an employee's base compensation package (e.g., by earning an amount of compensation per hour worked, or per task completed), and may also be awarded in exchange for performing one or more behaviors associated with an upsell, such as offering an upsell to a customer, or completing a transaction that includes an upsell (e.g., entering a customer's acceptance of an upsell offer). Compensation may be provided in monetary form, or non-monetary form (e.g., points exchangeable or otherwise redeemable for any of a number of particular products, or as recognition for an employee's performance). A “compensation function” is a formula or other algorithm that yields a compensation based upon at least one input value. “Compensation information” refers to information about at least one compensation.

An employee's success in leading a customer to accept an upsell which is offered along with a purchase being made by the customer will depend in large part on the employee's behaviors related to the upsell (e.g., offering the upsell). The rate of customer acceptance may be relatively high where the employee performs particular behaviors in offering the upsell, while the acceptance rate may be relatively low where the employee does not perform such behaviors. While the ultimate acceptance decision is made by the customer, the employee's behaviors related to the upsell tend to influence the decision. The methods and systems disclosed herein motivate employees to perform behaviors tending to increase the acceptance rate of upsells by customers, causing increased sales of upsells along with increased profitability for their employers.

In one example of the disclosed methods and systems, a customer enters a quick-service restaurant and orders a hamburger and a medium soda from an employee who is operating a point-of-sale (POS) terminal. The employee enters the order into the terminal, and the terminal calculates a subtotal of $2.35 for the order. This order and the calculated subtotal are transmitted to a computer for processing. The computer uses this information to determine that the customer should be offered a medium french fries (which ordinarily sells for $1.09, but has a marginal cost to the restaurant of only $0.15) as an upsell for an additional $0.65, which would bring the total for the transaction to an even $3.00. The computer also accesses a compensation database to determine that the employee may receive a compensation of 10 points for offering this upsell (i.e., a medium french fries for an additional $0.65) to the customer. Next, the computer accesses a goal database to determine that the employee operating the POS terminal has selected a goal item of a basketball, which is worth 1800 points. Then, the computer transmits a message to the terminal containing information about the upsell item, a prompt indicating the words the employee should use to offer the upsell item to the customer, the compensation amount associated with the upsell, and the employee's goal item. In response, the terminal uses a video screen to display a prompt to the employee indicating the words that should be used to offer the upsell to the customer. Alongside this prompt, the video screen displays a digital photograph of the employee's goal item and a bar graph indicating how the employee will progress towards attaining his goal if he offers the upsell. The employee may then offer the upsell to the customer, preferably based on the prompt. Using voice recognition, or an indication that the customer accepted the upsell offer, the terminal verifies whether the employee offered the upsell to the customer. If the employee made the upsell offer, the terminal generates a sound and displays another message on the video screen to inform the employee that he has just earned the 10 points offered for offering the upsell.

In this example, the computer and POS terminal operate to determine information about an upsell by determining the upsell (e.g., a medium french fries for an added $0.65), to determine a compensation associated with the upsell (e.g., 10 points for offering the upsell), and to output information about the compensation to the employee (e.g., by displaying the bar graph indicating how the 10 points being offered will progress the employee towards his goal of eaming the basketball). By providing the compensation information to the employee in real time, the employee may be more motivated to offer the upsell than if the information were not provided, making it more likely that the customer will accept the upsell (since the employee was motivated to make the offer, and since the prompt instructed the employee how to make the offer), thereby increasing the total sales and profitability for the employer. It thus becomes more likely that the employer will make the additional profit associated with the upsell, equal to the difference between the upsell price and the marginal cost of the upsell (i.e., $0.65-$0.15=$0.50). The employer can also benefit from the extra satisfaction experienced by the customer, who was provided with the opportunity to purchase the upsell at a discount from its normal selling price (i.e., for $0.65, not the normal $1.09).

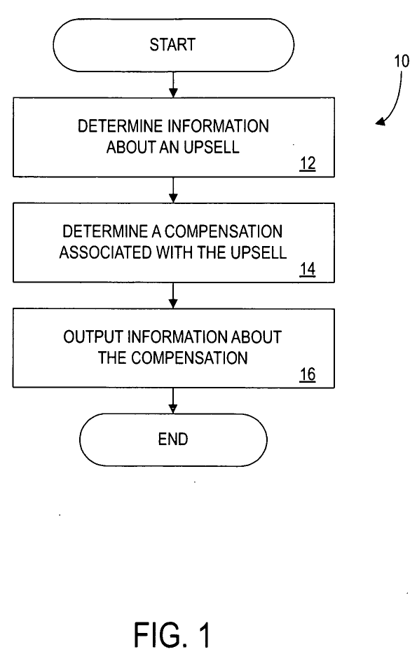

FIG. 1 is a flow chart illustrating an exemplary embodiment of a method for motivating an employee to perform a behavior related to an upsell by providing information about a compensation associated with the upsell to the employee (or other person such as the employee's manager) in accordance with the present invention. An embodiment of a method 10 for motivating an employee to perform a behavior related to an upsell by providing compensation information to the employee (or his manager), such as the method used in the above example, is shown in FIG. 1. Method 10 includes determining information about an upsell (step 12), determining a compensation associated with the upsell (step 14), and outputting information about the compensation (step 16). Each of these steps is described in detail further below.

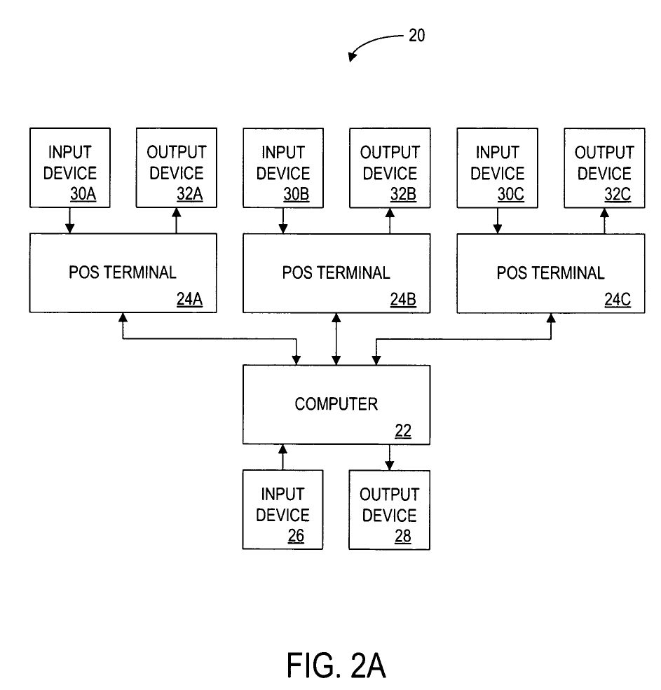

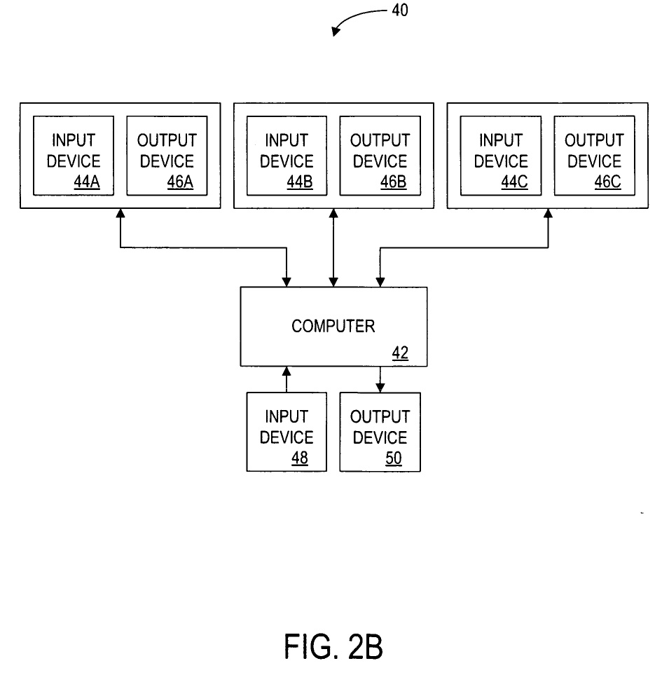

FIG. 2A is a hardware block diagram showing an exemplary embodiment of a computer system used to implement the method illustrated in FIG. 1. According to one embodiment, method 10 is implemented in any of various computer systems, including a computer system with a single computer (e.g., a central computer), a network of computers in communication with each other (e.g., via a LAN, WAN or the Internet), or a controller. Referring to the hardware block diagram of FIG. 2A, one embodiment of a computer system 20 for implementing method 10 includes a computer 22 which communicates with each of a plurality of POS terminals 24A, 24B, 24C. Computer 22 includes a processor, a program executed by the processor, a storage device for storing the program and databases, and a communication port. POS terminals 24A, 24B, 24C perform functions relating to processing purchases, and relating to processing upsell transactions. Some or all of the functions performed by computer 22 may also be implemented in the POS terminal(s). Computer system 20 can also include more or fewer than the three (3) POS terminals depicted in FIG. 2A.

Computer 22 receives input signals from an input device 26 in response to actions by an operator of computer 22 (e.g., a manager), and transmits output signals to an output device 28 to provide output indications to that operator. Each POS terminal 24A, 24B, 24C receives input signals from a respective input device 30A, 30B, 30C in response to actions by an operator of the respective terminal (e.g., an employee), and transmits output signals to a respective output device 32A, 32B, 32C to provide output indications to that respective operator. Each input device 26, 30A, 30B, 30C can include one or more physical input devices, each of which may include a switch, a keypad, a computer keyboard, a POS terminal keypad or keyboard, a touch-screen or a microphone. Each output device 28, 32A, 32B, 32C includes one or more output devices, each of which may include a video screen such as a cathode ray tube (CRT) monitor, a liquid crystal display (LCD) or a light-emitting diode (LED) screen, and may also include a light-bulb or LED having only two-states (e.g., on and off), a printer, an audio speaker, a set of headphones, an earphone, a telephone, a beeper, a pager, a cellular telephone, a laptop personal computer (“PC”), a personal digital assistant (“PDA”), or a wearable computer equipped with a video display and/or an audio output.

Each POS terminal 24A, 24B, 24C is configured to be operated by an employee, with each respective input device 30A, 30B, 30C used to input information in response to actions by the employee, and each respective output device 32A, 32B, 32C used to output information to the employee. Each input device 30A, 30B, 30C can be used to input information about a customer's initial purchase order, and information about an upsell to a customer such as information relating to whether an offer for the upsell was made by the employee or was made correctly (e.g., in accordance with an instruction provided to the employee by a prompt), whether the customer accepted the upsell offer, or which of several upsells was accepted. In the above example, the input device for the POS terminal was used to input the customer's initial purchase order of a hamburger and a medium soda, to input the employee's voice which was used to recognize whether the employee offered a medium french fries as an upsell, and to input an indication of whether the customer accepted the offer for the upsell. In other embodiments, voice-recognition is not used. In these embodiments, whether an employee receives compensation can depend on whether an upsell was accepted by a customer, as indicated by inputs to the POS terminal by the employee. Separate input devices can also be used to enter the initial order and the information about the upsell.

Each output device 32A, 32B, 32C of POS terminals 24A, 24B, 24C can be used to output information about a customer's regular purchase order, along with information associated with an upsell to the customer, such as information relating to the upsell and its additional cost to the customer, or relating to the compensation to the employee associated with the upsell. In the above example, the output device for the POS terminal is used to inform the employee that he should offer an upsell of a medium french fries for $0.65, that he will earn 10 points for offering the upsell which will be applied toward his goal of earning a basketball, and that he earned the 10 points upon making the offer. Separate output devices can also be used to output information about the customer's initial purchase order and the information associated with the upsell.

In one embodiment, computer 22 is configured to be operated by the employees' manager, or by another person with the authority to modify the operation of computer system 20. Using input device 26, that manager or person can modify or add information related to upsells to be offered by the employees, can modify compensations associated with various upsells and employees, and can prepare messages for output to employees. Using output device 28, that manager or person can receive information relating to the operation of the business, relating to the performance of each employee, or relating to the compensations being earned by each employee.

Referring to the hardware block diagram of FIG. 2B, another embodiment of a computer system 40 for implementing method 10 includes a computer 42 which communicates directly with a plurality of employee terminals, each including an input device 44A, 44B, 44C and an associated output device 46A, 46B, 46C. Computer 42 includes a processor, a program executed by the processor, a storage device for storing the program and databases, and a communication port. Each employee terminal may be, for example, a portable walkie-talkie worn by the employee, including a microphone to convert the employee's voice into electrical signals and earphones for providing sound to the employee. Computer system 40 can include more than or fewer than the three (3) employee terminals depicted in FIG. 2B, and each employee terminal may have an output device (e.g., an earphone) but no input device, or vice-versa. Computer 42 communicates with an input device 48 and output device 50, which are similar to input device 26 and output device 28 in FIG. 2A. Other system embodiments, including computers, processors, controllers, input and output devices and terminals, may also be used to implement the method of the invention.

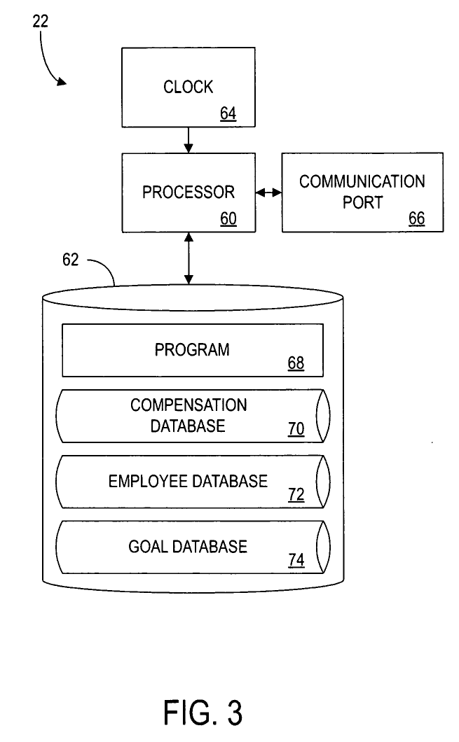

Referring to FIG. 3, computer 22 of FIG. 2A includes a processor 60, a data storage device 62 in communication with processor 60, a clock 64 which provides a clock signal to processor 60, and one or more communication ports 66 also in communication with processor 60. Processor 60 includes one or more microprocessors, such an Intel PENTIUM® microprocessor. Data storage device 62 includes any of a variety of memory devices, such as random access memory (RAM), read only memory (ROM), floppy disk, hard disk, optical disk or a combination thereof. Although data storage device 62 may be proximate to processor 60, data storage device 62 may also be located remotely from processor 60 and coupled thereto via a remote communication medium (e.g., the Internet). Data storage device 62 stores a program 68 which includes instructions executed by processor 60, and also stores data structures including a compensation database 70, an employee database 72 and a goal database 74, each accessible to processor 60. In some embodiments, employee and goal databases 72 and 74 are not used, and employees are provided with compensation as it is earned (i.e., “on the spot”). Clock 64 provides timing signals for controlling the execution of processor 60, and for use in determining information such as transaction rates for each employee or the elapsed times associated with offering or completing upsells. Communication port 66 includes one or more input/output interface circuits for communicating with each POS terminal 24A, 24B, 24C, input device 26, output device 28 and any other input devices, output devices or computer systems. Computer 42 in FIG. 2B has a structure similar to that of computer 22, with appropriate modifications such as to the interfaces of communication port 66.

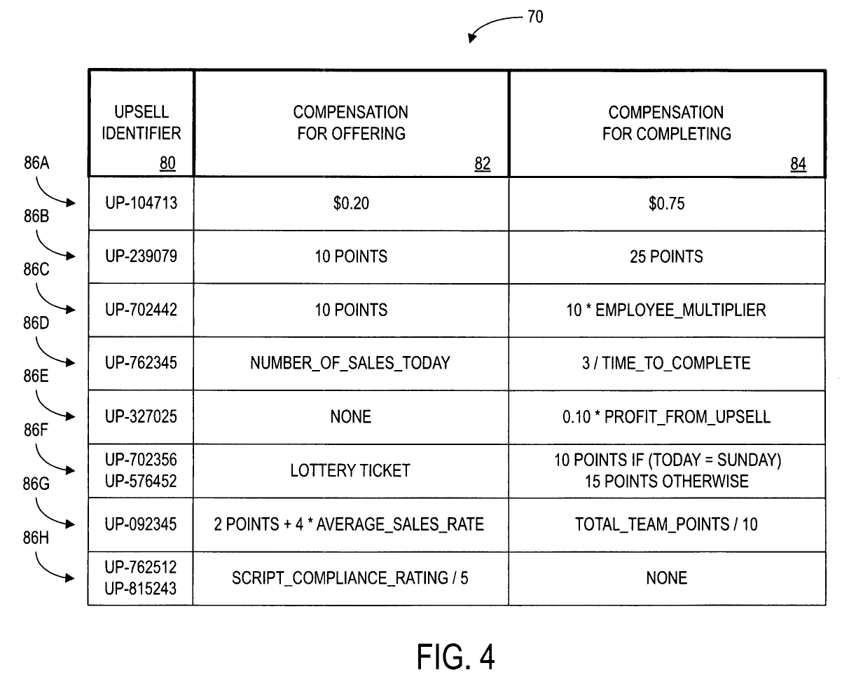

Referring to FIG. 4, an exemplary embodiment of compensation database 70 is represented by a table which stores information about compensations associated with particular upsells. For each possible upsell, compensation database 70 includes an upsell identifier field 80 for storing an upsell identifier that uniquely identifies an upsell (and could be used to index an entry in an upsell database), a “compensation for offering” field 82 for storing a compensation that may be earned by an employee for offering the upsell to a customer, and a “compensation for completing” field 84 for storing a compensation that may be earned by an employee for successfully completing the upsell (i.e., for causing a customer to accept the upsell that was offered).

Some upsells may have a compensation associated only with offering the upsell (e.g., record 86H, where the “compensation for completing” is “NONE”), while other upsells may only have a compensation associated with completing the upsell (e.g., record 86E, where the “compensation for offering” is listed as “NONE”). A unique record 86A-86H, each having fields 80, 82 and 84, can be associated with each possible upsell. Alternatively, as indicated by records 86F and 86H, more than one upsell can be associated with the same compensations (e.g., the compensation for offering both of upsells UP-702356 and UP-576452 is a lottery ticket). One upsell can also be associated with multiple compensations, which may depend on the time of day, transaction volume, cashier proficiency, specific customer data, etc. Compensation database 70 may have more or fewer records than the eight (8) records (i.e., 86A-86H) shown in FIG. 4, based upon the number of possible upsells that can be offered.

In other embodiments, each of the records 86A-86H could have more or fewer fields, or different fields, than those shown in FIG. 4. For example, each of the records 86A-86H could have only one of “compensation for offering” field 82 or “compensation for completing” field 84. Compensation database 70 could also have an upsell description field for storing a description of each upsell (e.g., upsell UP-104713 could be described as being a large soda). Further, compensation database 70 could store compensations associated with other behaviors related to upsells, where some of the compensations could even be earned for performing upsell behaviors unrelated to any particular upsell item. For example, compensation database 70 could store compensations which could be earned for checking to see which upsell items are available, for reporting a customer's reaction to an upsell offer, or for determining a new way to offer an upsell. The same compensation could also be provided for every possible upsell, in which case compensation database 70 may not be needed. For example, a compensation of $0.10 could be earned by an employee for offering any upsell, while a compensation of $0.20 could be earned for completing any upsell.

Each compensation may be described in a number of ways, including as a monetary value, a point value, a product (e.g., “You will receive a watch if your customer accepts this upsell offer.”), or as a compensation function (i.e., where the compensation that may be earned is computed as a function of one or more parameters). Record 86A shows an example of compensations described as monetary values, wherein an employee may earn $0.20 for offering upsell UP-104713, and $0.75 for successfully completing that upsell (i.e., having a customer accept that upsell). Record 86B shows an example of compensations described as point values, wherein the employee may earn 10 points for offering upsell UP-239079, and 25 points for successfully completing that upsell. Record 86D shows an example of compensations described as compensation functions, wherein the employee may earn a compensation equal to the number of sales made today (for example, in units of points) for offering upsell UP-762345, and may earn a compensation equal to three (3) divided by the time for completing the upsell in seconds (for example, in units of dollars) for successfully completing the upsell. Each upsell can also include different types of compensations associated with different types of behaviors. For example, record 86C shows that the compensation that may be earned for offering upsell UP-702442 is 10 points, while the compensation that may be earned when a customer accepts that upsell is 10 multiplied by a multiplier for the employee (and stored in employee database 72). Compensation functions are further described below. In one embodiment, compensation database 70 is combined with an upsell database similar to that shown in the U.S. Pat. No. 6,119,099, entitled “Method and System for Processing Supplementary Product Sales at a Point-of-Sale Terminal”, issued on Sep. 12, 2000.

In the embodiment described in relation to FIG. 4, the compensations associated with particular upsells are determined using a database approach. In another embodiment, the compensations associated with particular upsells are determined by rules stored in a compensation rules database using a rule-based approach (instead of or in addition to using fields 82 and 84 in database 70). One exemplary rule is: given an employee's current rate of pay, the current upsell acceptance rate and a target upsell acceptance rate, increase the employee's compensation based upon a percentage of his current rate of pay which depends upon the difference between the current and target acceptance rate. Other rules may define “bonus” pay dynamically associated with aging inventory, or with particularly difficult upsell offers (e.g., an upsell offer for an item more expensive than the typical upsell item, or an upsell offer for multiple items).

To improve the ease with which the system can be set-up and modified, various rules can be grouped into “categories”, with each category being assigned a category code. Future revisions could then be made at the category level, with each revision affecting one or more compensation offers that are stored within the database for the compensation data or rules. These systems could be managed locally, or could be managed remotely at a regional or central location. The data or rules could be created to reflect similarities or differences among multiple locations. For example, the employees at a first store may respond more favorably to a points-based compensation method while the employees at a second store may respond more favorably to cash-based compensations. These options could apply to individual employees, groups of employees, individual stores, groups of stores, etc. Further, certain attributes relating to individuals or to stores may be identified as being significant in affecting employee behavior compliance rates. Accordingly, the database may store these attributes, which may affect compensations offered to employees, either individually or collectively.

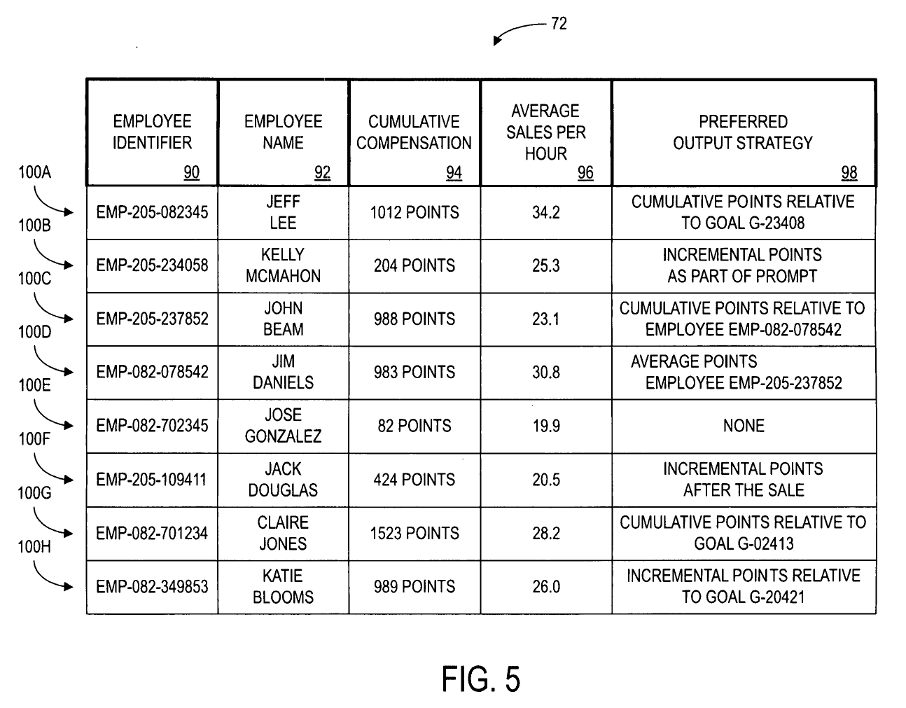

Referring to FIG. 5, an exemplary embodiment of employee database 72 is represented by a table for storing information about employees. For each employee, employee database 72 includes an employee identifier field 90 for storing an employee identifier that uniquely identifies an employee, an employee name field 92 for storing the employee's name, a cumulative compensation field 94 for storing a cumulative amount of compensation earned by the employee, an average sales per hour field 96 for storing the average number of sales transactions per hour by the employee, and a preferred output strategy field 98 for storing an output strategy selected for outputting compensation information to the employee. A unique record 100A-100H, each having fields 90, 92, 94, 96 and 98, is associated with each employee. Employee database 72 may have more or fewer than the eight (8) records shown, based on the number of employees. Further, each of the records 100A-100H can have more or fewer fields, or different fields. For example, cumulative compensation field 94 is particularly useful in embodiments wherein cumulative compensation information may be output to the employee (either in real-time, or as requested by the employee (e.g., when signing in or out of a shift)). Average sales per hour field 96 may or may not be included, and is shown to exemplify other types of information that may be stored in employee database 72. These other types of information could include transaction information, payment identifiers, team information, and success rates achieved by each employee for upsells.

Preferred output strategy field 98 may be included in embodiments of the invention wherein an employee, manager, or computer 22 can select which output strategy will be used for a particular employee. For example, this field may store a particular output strategy by which an employee prefers to have his compensation information output to him (e.g., cumulative points relative to goal G-23408), or to store a particular output strategy which the employee's manager believes is more likely to maximize the employee's motivation to perform behaviors related to upsells. In one embodiment, the preferred output strategy is determined by computer 22 based upon feedback information, as further described below. Employee database 72 could have another field indicating how a preferred output strategy was selected for each employee (e.g., by the employee, his manager or computer 22). Alternatively, a preferred output strategy could be selected directly by an employee during operation of a POS terminal (e.g., using an input device such as a switch on his POS terminal) and preferred output strategy field 98 may not be as useful. In another embodiment, the system may test multiple output strategies to determine which strategy is most effective in ensuring employee behavior compliance.

Based on record 100A in FIG. 5, for example, information stored in employee database 72 indicates that employee identifier EMP-205-082345 has been associated with a Jeff Lee, an employee who has earned a cumulative compensation of 1012 points, is averaging 34.2 sales transactions per hour, and has selected a preferred output strategy of having his compensation information output to him as the number of cumulative points relative to a particular goal (identified by a goal identifier G-23408).

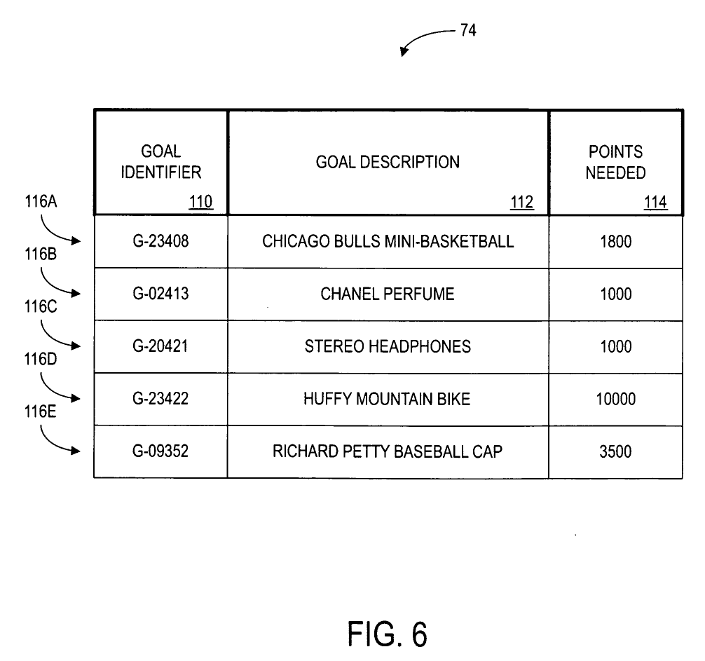

In one embodiment of the invention, points earned by employees may be exchanged or otherwise redeemed for any of a number of particular goal items, with a predetermined number of points being associated with each goal item. Referring to FIG. 6, an exemplary embodiment of goal database 74 is represented by a table which stores information about goals. For each goal, goal database 74 includes a goal identifier field 110 for storing a goal identifier that uniquely identifies a goal, a goal description field 112 for storing a description of the goal, and a points needed field 114 for storing a number of points needed to attain the goal. A unique record 116A-116E, each having fields 110, 112 and 114, is associated with each goal. Database 74 may have more or fewer records than the five (5) records shown, based upon the number of possible goals. Further, each of the records 116A-116E can have more or fewer fields, or different fields. For example, an additional field could provide a link to graphical data which could be used to generate a graphical representation of the goal on output device 32A, 32B, 32C of POS terminal 24A, 24B, 24C, respectively, perhaps by identifying a graphical file (e.g., a JPEG file) which stores a digital representation of that goal (e.g., a digital photograph of the goal item). Goal database 74 may be used to store information about monetary and/or non-monetary goals (e.g., an employee could earn $0.10 per upsell, with a first bonus of $5 for making 80 upsells and a second bonus of a free compact disk for making 150 upsells). Note that goal database 74 may not be needed in some embodiments, such as where only incremental or cumulative monetary compensations are available (e.g., an employee earns $0.10 per upsell, with no bonus), and other methods for allowing employees to work towards attaining non-monetary goals may be used that are not point-based. For example, an employee could attain a goal of earning a new basketball for successfully completing 50 upsell transactions.

Based on record 116A in FIG. 6, for example, information stored in goal database 74 indicates that goal identifier G-23408 has been associated with a Chicago Bulls mini-basketball, and that a total of 1800 points is needed to receive this goal.

### Motivating an Employee to Perform a Behavior Related to an Upsell

Referring back to FIG. 1, the steps of method 10 are now discussed in further detail. Although the following discussion assumes that method 10 is performed using computer system 20 of FIG. 2A, this discussion also applies when method 10 is performed using computer system 40 of FIG. 2B, except for the particular hardware components involved. It will be appreciated that method 10 can also be performed using other hardware configurations, such as where each POS terminal performs some or even all of the functions described below as being performed by computer 22.

Determining Information about an Upsell

At step 12, computer 22 is configured to determine information about an upsell. An upsell is a product offered along with a purchase being made by a customer who is conducting a purchase transaction at any of POS terminals 24A, 24B, 24C. An upsell may have a predetermined upsell price (e.g., an upsell of a medium french fries may always be offered at a fixed upsell price of $0.60), or the upsell may be a dynamically-priced upsell which is offered at a price not determined until the time of the transaction (e.g., similar to the upsell of medium french fries for $0.65 as described above, which was set to bring the total purchase price for the order to an even $3.00). The upsell may tend to be a dynamically-priced upsell in embodiments of the invention where an upsell is offered in exchange for a customer's spare change, although it would also be possible to offer an upsell at a predetermined price in exchange for a customer's spare change (e.g., whenever the change due a customer is $0.15, offer a large soda as an upsell). The dynamic price of the upsell may also be determined as a function of time, the identity of the customer, upsell inventory, the identity of the store, or another parameter. The information about an upsell determined by computer 22 at step 12 may include information about an upsell to be offered to a customer in the future, about offering an upsell to a customer, or about a result of offering an upsell to a customer.

Computer 22 may determine information about an upsell to be offered by an employee to a customer in the future (i.e., “a future upsell”) by determining the future upsell to be offered (i.e., wherein determining information about the future upsell is implicit in determining the future upsell). For example, based on a customer's order of a hamburger and medium soda, computer 22 may determine that a future upsell of a medium french fries should be offered to the customer. Other types of information about an upsell which may be determined include the cost of purchasing the upsell, the employee to offer the upsell, when the upsell will be offered, how the upsell should be offered, and which customers the upsell will be offered to. Methods and systems for determining an upsell are disclosed in the U.S. Pat. No. 6,119,099, entitled “Method and System for Processing Supplementary Product Sales at a Point-of-Sale Terminal”, issued on Sep. 12, 2000, which is incorporated herein by reference.

Alternatively, computer 22 may determine information about an upsell to be offered by receiving information relating to the future upsell from a second computer system. In this case, separate computer systems may implement method 10 and the method of determining an upsell. For example, computer 22 may receive information from another computer system (such as that disclosed in U.S. Pat. No. 6,119,099, entitled “Method and System for Processing Supplementary Product Sales at a Point-of-Sale Terminal”, issued on Sep. 12, 2000; not shown in FIG. 2A) indicating that a particular prompt has been selected, or that a prompt may be issued for a given transaction. The prompt could instruct an employee that he should perform a selected behavior relating to a future upsell (e.g., offer a medium french fries as an upsell). As another example, method 10 could be implemented entirely within each POS terminal 24A, 24B, 24C, with each terminal receiving information relating to a future upsell from computer 22 (which would determine the upsell). Determining information about a future upsell is particularly useful for embodiments of the invention wherein compensation information is output along with a prompt, as described below in the discussion relating to step 16.

Computer 22 may determine information about offering an upsell to a customer by determining various types of information relating to the actual process of offering the upsell to the customer. For example, computer 22 may determine whether or not an employee offered an upsell to a customer by using a microphone in input device 30A, 30B, 30C to convert the employee's voice into electrical signals, and then using a voice-recognition circuit or application to analyze the signals to determine if the offer was actually made. Voice-recognition may also be used to determine whether the employee correctly spoke a verbal message associated with offering the upsell (e.g., based on the tone of voice, the customer's response, etc.), such as a message provided to the employee as part of a prompt. A method of verifying that an employee offered to sell an upsell correctly is disclosed in U.S. Pat. No. 6,567,787 entitled “Method and Apparatus for Determining Whether a Verbal Message was Spoken During a Transaction at a Point-of-Sale Terminal”, issued on May 20, 2003, incorporated herein by reference. Further, in embodiments of the invention wherein an employee has freedom to select which upsell will be offered from among a plurality of possible upsells, computer 22 may determine which upsell was offered. The particular product that was offered may be determined using voice recognition similar to that disclosed in U.S. Pat. No. 6,567,787 entitled “Method and Apparatus for Determining Whether a Verbal Message was Spoken During a Transaction at a Point-of-Sale Terminal”, issued on May 20, 2003, or by having the employee (or customer) operate an input device that generates a signal representing which product was offered. For example, the employee could actuate an input device (e.g., a switch on a keypad of a POS terminal) to indicate that a medium french fries was offered as an upsell rather than an apple pie. Similarly, other embodiments of the invention provide an employee with some freedom to determine how an upsell is offered to a customer. For example, an employee may be allowed to choose from several choices of possible languages to use when offering the upsell (which may be provided to the employee using one or more prompts), or the employee may be allowed to choose his own words when offering the upsell. In either case, computer 22 determines how the upsell was offered using voice recognition technology similar to that discussed in U.S. Pat. No. 6,567,787 entitled “Method and Apparatus for Determining Whether a Verbal Message was Spoken During a Transaction at a Point-of-Sale Terminal”, issued on May 20, 2003, or could receive a signal from an input device (e.g., a touch-screen on a POS terminal operated by the employee) which represents how the upsell was offered. In another embodiment, an employee is requested to use an input device 30A, 30B, 30C to confirm that he offered an upsell. For example, an output screen on an employee's POS terminal may display the prompt, “After you offer the upsell, push the F5 function key to receive $0.25”. By pushing the F5 function key, the employee will earn the $0.25 by confirming not only that he offered the upsell, but also that he read or viewed the prompt. By providing compensation to an employee simply for reading a prompt and performing a prompted action (regardless of whether the employee is confirming an upsell offer), employees can be encouraged to pay attention to prompts.

In one embodiment, computer 22 uses the clock signal generated by clock 64 to determine an elapsed time associated with an upsell offer. The elapsed time may represent, for example, the time between when an employee is prompted to make an offer for an upsell, and when the employee has completed making the offer. Based on the elapsed time, computer 22 can track how responsive employees are to prompts, and the results can be used to determine compensations and encourage employees to process transactions more quickly. For example, computer 22 may output a prompt to an employee stating: “Offer this customer an apple pie for his $0.30 in spare change within 15 seconds, and you'll earn a $0.10 bonus.” In this example, computer 22 uses the clock signal to track the time from when the prompt was output to the employee until an indication is received that the offer was made (e.g., a signal from a voice-recognition circuit), and will credit the employee with an additional $0.10 if the indication that the offer was made is received within 15 seconds of the prompt being output.

Computer 22 may also use the clock signal to prompt an employee to abort an upsell offer if too much time elapses between when the employee makes an upsell offer and when a customer responds to the offer. For example, if the elapsed time exceeds a predetermined value, the customer may be confused by an upsell offer, and it may be more efficient to abort the upsell offer than to explain the upsell offer.

Computer 22 may also determine information about an upsell by determining a result of offering the upsell to a customer. For example, computer 22 may receive information from a POS terminal indicating whether the upsell was successful (i.e., did the customer accept the offer for the upsell?). Whether the customer accepted the offer can be determined using a signal received from an input device (e.g., a keypad on the employee's POS terminal, or a touch screen display facing the customer), using voice recognition to recognize the customer's verbal acceptance, or by examining a transaction record generated by the POS terminal (or computer 22) which includes a field for storing data indicative of whether the customer accepted or rejected the upsell offer. In another embodiment, a customer is given a choice of possible upsells (or an employee is allowed to choose which upsell to offer), and computer 22 determines which product was selected by the customer. This choice can be determined using a signal received from an input device (e.g., a switch on a POS terminal indicating the first product was chosen), using voice recognition, or by examining a transaction record which includes a field for storing data indicative of which of the plurality of possible products was selected by the customer.

In one embodiment, computer 22 uses the clock signal generated by clock 64 to determine an elapsed time associated with a result of an upsell. The elapsed time may represent, for example, the time between when an employee is prompted to make an offer for an upsell, and when a customer responds to the upsell offer. This information can be used by computer 22 for determining compensations, and for encouraging employees to process transactions more quickly. For example, computer 22 may display a prompt on an employee's POS terminal stating: “Successfully complete this transaction with the customer within 30 seconds or less, and you'll receive a 20 point bonus.” In this example, computer 22 uses the clock signal to track the elapsed time between when the prompt was output to the employee, and when the customer's acceptance of the upsell is input to the POS terminal (e.g., using a switch on a keypad of the POS terminal), and then credits the employee with an additional 20 point bonus if the acceptance indication was received within the 30 second time period.

In other embodiments, other information about an upsell is determined at step 12. For example, the information which is determined may include the cost of an upsell (e.g., since the offering price of a dynamically-priced upsell can change as a function of time, the identity of the customer, the upsell inventory, the identity of the store or another parameter), the results of checking to see what upsell items are available (e.g., aging food products, excess inventory), a customer's reaction to an upsell offer (e.g., happy, indifferent, irritated) or a new technique for offering an upsell.

Determining a Compensation Associated with an Upsell

The compensation associated with an upsell, as determined by computer 22 at step 14, may be earned by an employee for a number of possible reasons. In one embodiment, computer 22 determines an amount of compensation which depends upon one or more behaviors performed by an employee which are associated with the upsell. The compensation can depend upon whether a particular behavior was performed (or not performed), and can also depend on the degree to which the behavior was correctly performed. By providing this compensation, computer system 20 tends to motivate the employee to perform (or not to perform) the behavior. For example, an amount of compensation may be determined based on whether an employee offered an upsell to a customer, and may be adjusted based upon the degree to which the employee correctly offered the upsell (i.e., based upon how the upsell was offered). Thus, a first amount of compensation may be determined if the employee makes an offer for an upsell, and a second, higher amount of compensation may be determined if the employee used the words suggested in a prompt to make the offer. For example, an employee may receive 10 points for conforming the offer exactly or nearly-exactly to the wording in a prompt.

In the above example, an amount of compensation is determined based upon a behavior of an employee in offering an upsell to a customer. The compensation can also be determined based upon other employee behaviors related to an upsell. For example, the amount of compensation can also be determined based upon whether the customer accepted an upsell in response to the employee's behavior (i.e., based upon whether the upsell was successfully completed). Other possible employee behaviors for which an amount of compensation can be determined include checking to see which upsell items are available (e.g., which food products are aging and should be sold soon? What items have excess inventory and should be sold to decrease inventory costs?), reporting a customer's reaction to an upsell offer (e.g., happy, indifferent, irritated), finding a new way to speak an upsell offer, or determining whether to offer an upsell.

Computer 22 may determine a compensation associated with an upsell according to any of a wide variety of compensation systems or schemes, which may be used individually or in combination. The compensation system may also be referred to as a commission system, and the different methods of determining compensations can be referred to as compensation methods. Possible compensation systems include a performance compensation system, a progressive compensation system, a team compensation system, a competitive compensation system, a dynamic compensation system, a profit-sharing compensation system, or a pyramid or multi-level marketing compensation system. Other compensation systems or methods may also be employed, including a multi-variant compensation system for maximizing multiple variables.

With a performance compensation system, a compensation earned by an employee is determined by computer 22 based upon one or more measurements of the employee's performance or behaviors performed by the employee. For example, an employee may earn a percentage of the total sales value of the upsells accepted by his customers (e.g., 10% of the $100 in upsells accepted by his customers during his shift).

With a progressive compensation system, a compensation being earned by an employee changes with the amount of compensation earned. Increasing levels of compensation may motivate an employee to work harder, thus preventing the employee from becoming complacent after repeatedly earning the same compensation for a period of time. For example, an employee may earn $0.10 for completing his first ten upsells, $0.15 for completing his second ten upsells, and $0.20 for completing each additional upsell. In this situation, the employee may be motivated to earn the higher $0.20 compensations as soon as possible. The compensations being earned can also decrease with the amount of compensation earned. For example, an employee could earn $1.00 for offering each of his first five upsells, and earn only $0.10 for offering each additional upsell. This decreasing progression could be used to increase the compensation levels of employees as they are being trained, possibly alleviating frustration felt by the employees during this process.

With a team compensation system, an employee is paid according to the performance or behaviors of his entire team, thereby encouraging employees to work together in teams to provide better service to customers. For example, every first shift employee of a quick-service restaurant could earn a $5.00 bonus if the customer acceptance rate for upsells offered by all of the employees during that shift exceeds a specified percentage (e.g., above 25%). The use of team compensations can result in the advantageous use of peer pressure on the employees to increase upsell productivity.

With a competitive compensation system, an employee is paid according to his performance or behavior relative to one or more other employees. For example, every employee at a quick-service restaurant can participate in a competition to receive a prize given only to whoever makes the most upsell offers during a week. The use of such a system may motivate employees as they strive to best their fellow employees. The competition may be between individual employees, or may be based upon teams. For example, the employees of a first store could compete against the employees of a second store, or the early shift employees could compete against the late shift employees, etc. Dividing up the employees into teams may help to encourage the team members to cooperate with one another to increase their collective performance level.

With a dynamic compensation system, the compensation earned by an employee can vary in accordance with one or more parameters. For example, an employee could earn a compensation of $0.20 for each upsell accepted by a customer on a Tuesday, but only $0.10 for each upsell accepted on a Saturday. Such a dynamic compensation system could help to offset the effects of non-peak vs. peak selling hours on compensations, or could be used to prevent an employee from becoming habituated to selling only a certain item as an upsell (e.g., a compensation associated with an upsell could decrease each time that upsell is offered). Dynamic compensations could also be computed in real-time (i.e., “on the fly”) based upon at least one predetermined parameter (e.g., the compensation earned for an upsell product could increase with the amount of inventory of that upsell, which could be particularly advantageous where the upsell product has a limited shelf life, as in the case of pre-cooked quick-service foods). Other parameters affecting an amount of compensation earned by an employee in a dynamic compensation system may include the transaction rate, upsell rate, length of the transaction, relative difficulty of achieving customer acceptance of the upsell offer (e.g., higher-priced or lower-discounted upsell offers may face more difficulty being accepted than lower-priced or higher-discounted upsell offers, respectively), length of the offer, speed of service time, the duration of the customer acceptance process, etc.

With a profit-sharing compensation system, a compensation earned by an employee is based on the profit generated by the employee's behavior. For example, an employee could earn a compensation equal to 50% of any additional profit made by the business due to an upsell transaction. For another example, a cashier at a quick-service restaurant may be prompted to offer a particular upsell item to a customer at any price within a range of prices. If the cashier is successful in selling this item, the compensation earned may be equal to or proportional to the difference between the price paid by the customer and the lower end of the price range. As a more specific example, the cashier could be prompted to offer an upsell of a milkshake to a customer at any price between $0.20 and $0.50 ($0.20 being the lowest price that the business is willing to accept for selling the upsell). If the cashier successfully sells the milkshake for $0.40, the cashier could receive 50% of the difference between $0.40 and $0.20, or $0.10, as his compensation. Such a profit-sharing system could motivate an employee to attempt to maximize the amount of profits that are earned by his employer.

With a pyramid compensation system, employees are organized into a multiple-level “pyramid”, and each employee is paid according to his own behavior and the behavior of those subordinate employees below him in the pyramid (who are typically, but not necessarily, supervised or managed by the employee). For example, while a new hire might earn a compensation based only on the percentage of his own transactions where he makes an upsell offer, the shift manager could be paid based on the percentage of transactions where any of the people working during that shift make an upsell offer. Such a multi-level marketing (MLM) compensation system could motivate higher-level employees to effectively supervise the people within the pyramid whom they are responsible for since they would earn a share of the extra compensation.

While various methods of calculating compensations associated with an upsell have been discussed, it is to be understood that other compensation systems could also be used in accordance with the present invention. A promotion compensation could be used wherein an employee earns a compensation or receives additional compensation based on whether a particular upsell is being promoted. For example, an employee at a restaurant could earn an added compensation for offering, as an upsell, a new type of dessert that is currently being promoted by the restaurant. With a multi-variant compensation system, an employee is paid according to his ability to maximize multiple variables. For example, employees may be paid based on their ability both to increase upsell offer acceptance rates and to improve overall service times. Any number of related variables may be measured, including profits and customer satisfaction levels, inventory turnover and product freshness, average check amounts and gross profit, sales per hour and average labor costs, etc.

In addition to the various methods of calculating a compensation associated with an upsell, the compensation may be provided to the employee using various methods of payment, and may have a number of different forms. For example, a compensation can be paid to an employee as part of a regular paycheck received by the employee (e.g., included within the employee's regular weekly paycheck), or can be paid in an extra paycheck. The compensation can be paid by being credited to an account associated with the employee, such as by being automatically credited to a specified financial account (e.g., a bank or credit card account) in the employee's name. For example, the compensation could be credited to an employee's account using a link to a payroll system such as ADP, an automated payment via the Internet (e.g., Paypal.com), and/or other reward system (e.g., 4aspire.com). The compensation could also be paid via a coupon mechanism, such as by giving the employee a receipt, coupon or check which can later be exchanged for money, goods or services (e.g., admission to a movie theater). Further, the compensation could be paid by providing incremental payments to the employee over a payment schedule (e.g., the employee could be paid $20 total at a rate of $5 per week for the next four weeks). In one embodiment, the employee could be instructed by computer 22 to simply obtain his compensation. For example, a restaurant employee could be instructed to take $1 out of the POS terminal, or to have a hamburger, at the end of his shift. The foregoing methods of payment can also be combined, such as by providing part of the compensation earned for making upsells in the employee's paycheck, and allowing the employee to obtain the remainder of his compensation in the form of free food.

If the compensation earned by an employee is in the form of recognition, the employee's manager may be prompted to recognize the employee (e.g., in real-time or close to real-time with respect to the employee's behavior, or at a convenient time such as the end of a shift or a slow period). The recognition can also be provided by a message displayed to the employee, and/or to the employee's co-workers or customers.

Note that, even in embodiments of the invention where an employee actually receives his compensation associated with upsells at a time significantly after the compensation was earned (e.g., in his weekly paycheck), the employee still receives an indication of the compensations that he has earned or will earn contemporaneously or nearly-contemporaneously with his behavior (e.g., from a message displayed on his POS terminal at the time of the upsell transaction), thereby maintaining a close tie between the employee's behaviors related to upsells and his associated compensations. Information about the compensation is thus output to the employee at “substantially” the same time that the upsell is being offered (i.e., so that the information is output in association with the particular upsell transaction, rather than another upsell transaction).

In one embodiment, an employee is only paid a compensation otherwise “earned” for his behaviors related to upsells if a threshold is achieved. Such a threshold may be used, for example, to prevent an employee from being paid compensation for his behaviors related to upsells that did not, in fact, result in any extra profits being made by the employer. For example, an employee could be paid the compensation that he otherwise “earned” during a shift for performing behaviors associated with upsells only if the number of upsells that he successfully completed during the shift exceeded a predetermined number. In the event that none of the employee's upsell offers were successfully completed, the employer will have earned no extra profits, and may not believe that the employee deserves to be paid any extra compensation for his behaviors. This type of threshold function may prevent situations where an employee tries to abuse the upsell compensation system by repeatedly performing only certain behaviors associated with upsells without actually trying to successfully complete the upsells (e.g., where he uses a very unfriendly tone when making upsell offers to his customers).

Another threshold may depend upon a result of the business as a whole. For example, employees of a quick-service restaurant could be paid the compensations that they otherwise “earned” for their behaviors related to upsells only if a particular management goal was met (e.g., only if the restaurant made a profit). In one embodiment, the compensations earned for behaviors related to upsells could be used as inputs to a profit sharing plan to divide up all or a portion of the business' profits. For example, each employee could be paid a share of the business' profits as a percentage of his upsell compensations to the total upsell compensations of all of the employees.

In many of the above examples, the compensation is denominated in monetary terms (e.g., in terms of dollars). The compensation may also be provided in an alternative, non-monetary form of currency. For example, the compensation may be provided in terms of points with a certain number of points being allocated for each behavior. Points may be used to prevent employees from becoming discouraged by low incremental compensations. For example, an employee may find it more appealing to receive 200 points, as opposed to $0.20, for performing a behavior. Non-monetary compensations such as points can, as with monetary compensations, be accumulated over time, and the various compensation systems and methods of payments described above in relation to monetary compensations can also be applied when points are used.

In one embodiment, employees are able to convert earned points into money, goods or services using a trade-in system. For example, an employee may be allowed to trade 1800 points for a new basketball. The goods or services available for purchase, and the number of points required to purchase those goods or services, may be defined by a catalog, or by a goal database such as database 74 in FIG. 6. The use of points as compensation can be beneficial to employers because it allows employers to encourage their employees to spend their compensation in certain ways. For example, employees could be given the option to trade 10,000 points in exchange for tuition for a computer-training class that would provide the employees with additional work-related skills. The use of points could also allow employers to effectively increase the value of the compensation they provide, thus providing an edge compared to their competitors. For example, an employer could negotiate for reduced-price movie tickets with a movie theater, and then give its employees the option to trade 1000 points for a free movie ticket, thereby enabling the employer to provide extra value to its employees.

In one embodiment, the number of points has a linear relationship with the number of monetary units (e.g., the number of dollars equals the number of points divided by 10, such that 10 points corresponds to a monetary benefit of $1.00 and 100 points corresponds to a monetary benefit of $10.00). However, the use of a point-denominated compensation system can be advantageous in that there need not be a linear relationship between the numbers of points and the corresponding monetary benefit. Thus, for example, while 10 points may correspond to a monetary benefit of $1.00, 100 points may correspond to a monetary benefit of only $5.00 (rather than the $10.00 that would occur with a linear relationship). Employers can use the flexibility provided by using points to design compensation systems that make the monetary benefits corresponding to the number of earned points less apparent to the employees, or to provide increasing or decreasing rates of monetary benefits as points are earned.

Additionally, the conversion of points into money, goods or services can depend on other factors, such as an employee's seniority, a short-term promotion, the time of day, etc. For example, a senior employee may be required to trade 1000 points in exchange for a free movie ticket, while a junior employee may be required to trade 2000 points in exchange for the same movie ticket. For another example, an employee may be allowed to obtain a particular food item for only 100 points at the end of a day (or as the food nears the end of its shelf life), while the same food item would have required 200 points earlier in the day (or earlier in its shelf life).

The number of earned points or dollars accumulated since an employee was hired, or during a particular period of time, could also be used to make the employee eligible for an additional or enhanced benefit. For example, an employee who earned more than 1000 points last month could be eligible for a reduction in the co-pay on his insurance premium, or could qualify the employee for a promotion (e.g., in his position or hourly rate). Once achieved, this added or enhanced benefit could be reduced or retracted in the event the employee fails to maintain his performance level. An employee could thus achieve a short-term promotion that could last for a short amount of time (e.g., a month, a week, or only a shift). Further, an employee's base level of points earned or “on account” may be increased or multiplied to a greater number of points if his overall performance rating is at or above a certain threshold level. This increase in the number of points may serve to encourage the employee to both increase his number of points and to maintain long-term positive behaviors.

Compensation in the form of goods and services may also be provided in exchange for particular behaviors, independent of a points system. For example, an employee could be compensated with time off (e.g., a two-hour lunch break) for successfully completing the sale of a valuable upsell, such as where a customer agrees to purchase rustproofing as an upsell to the purchase of a new automobile. Other examples include entering an employee who offers 1000 upsells into a lottery for an expenses-paid trip to Hawaii, or rewarding employees with coupons or other discounts on goods and services. Compensation in the form of goods and services may be provided using any of the compensation methods of payment discussed above.

In one embodiment, the compensation associated with an upsell that can be earned by an employee is provided in the form of a coin or token for use in playing a game of chance. For example, an employee at a casino restaurant could earn tokens for performing behaviors associated with upsells, and could use these tokens to play a slot machine located in the casino in hopes of winning a prize based on the random outcome of the slot machine play. Thus, the token would not represent a guaranteed prize, but would represent a chance of receiving a prize. The use of tokens as compensation would allow an employer to offer its employees the possibility of earning relatively large prizes (i.e., prizes having a value exceeding any guaranteed compensation for the employee), and would also introduce entertainment into the compensation system. Alternatively, the employee could earn free spins at a slot machine, without the need for physical tokens. The slot machine may be a separate slot machine which receives data from computer system 20 indicative of the number of free spins earned by an employee, or a slot machine integrated into computer system 20 (e.g., a virtual slot machine implemented using the video display of the employee's POS terminal to present a virtual display of the slot machine's spinning reels). Alternatively, the game of chance may be a raffle, a video poker game, or any of a number of other games of chance, and the compensation can be provided in any form suitable for playing such games. These games of chance could also occur automatically. For example, each time that a customer accepts an upsell offer, the employee could be made eligible for a random drawing. The drawing results could be determined immediately or at some future date.

In an alternate embodiment, the compensation associated with an upsell that can be earned is provided using the illusion of chance (from the employee's perspective), without actually introducing the element of chance into system 20. In one implementation, an employee accumulates points (or tokens) over a period of time or a number of transactions, and then uses these points for free spins on a slot machine (a physical or virtual slot machine), with the outcome of the slot machine play being predetermined so that the employee's ultimate compensation does not depend upon the element of chance. For example, an employee who earns 10 points may use his points for 10 free spins of a virtual slot machine in his POS terminal, with the virtual slot machine programmed to insure that the employee “wins” a set payout amount (e.g., the employee could win a $1 payout three times, for a total compensation of $3). While the outcome of each spin may appear random to the employee, the employee's ultimate compensation would be predetermined (e.g., so he is assured of “winning” $3 over the 10 spins). Such a system would allow compensations to be provided in an entertaining fashion, without affecting the compensation amount. In another implementation, each play of a gaming device is worth a fixed amount, which is “won” by an employee based upon the random outcome of each play, with any unearned payouts accumulated by the gaming device and paid out on the next “win” such that the employee “wins” a guaranteed amount over a series of spins. For example, an employee may earn one (1) free spin of a slot machine for each upsell offer that is accepted by a customer. If the employee “wins” on a spin, he receives 10 points. However, if he loses, he receives nothing, but the unearned 10-point payout is accumulated in a jackpot that is paid out to the employee on his next “win”. The jackpot continues to grow by the same amount for each “losing” spin. Thus, if the employee loses on nine (9) straight spins but wins on the 10th spin, he will receive a payout of 10*10 points=100 points. Thus, the employee's guaranteed compensation of 100 points is delivered in entertaining fashion.

The compensation associated with an upsell can also be provided in the form of employee recognition, which can be provided in addition to or as a substitute for other forms of compensation. For example, an employee who successfully completes the most upsells in a given month may be recognized for this achievement via a company-wide announcement concerning the employee (e.g., by being pictured on an “employee-of-the-month” poster, or by sending a message displayed on each POS terminal), by receiving an achievement token (e.g., a badge or a pin), or by being promoted to a higher position. The recognition may be provided by the employee's manager, or by displaying a message to the employee. The recognition may be made privately to the employee or publicly. The recognition may be provided to an employee at the time of the behavior being rewarded, or the recognition may be provided at a deferred time, or both. In some cases, the motivation provided to employees via recognition may be more effective than that provided by other types of rewards.

In one embodiment, different employees receive different compensation for performing the same behavior, thus providing a personalized compensation system. The personalized compensation can be used as a training tool directed to a particular employee, as a way to vary the compensation rates among employees based on factors such as years of service, or to provide compensation in a form which maximizes its value to a particular employee. For example, an employee who is new to a position may receive greater compensation for performing certain behaviors, thereby motivating him to learn those behaviors. For another example, an employee who likes to listen to music may prefer to receive vouchers for compact disks as personalized compensation, while a second employee who likes to play basketball may prefer to receive a discount on a new pair of basketball shoes as personalized compensation. In a further embodiment, an employee may be permitted to select his own form of personalized compensation via, for example, actuations of input device 30A, 30B, 30C. For example, an employee may be permitted to select one of the goals in goal database 74.

In one embodiment of the invention, a compensation is associated with a specific prompt, with the prompt being determined as described in U.S. Pat. No. 6,119,099, entitled “Method and System for Processing Supplementary Product Sales at a Point-of-Sale Terminal”, issued on Sep. 12, 2000, incorporated herein by reference. In this embodiment, computer 22 determines a compensation associated with an upsell by accessing a database such as compensation database 70 (FIG. 4) to determine the compensation associated with the specific prompt. As shown in FIG. 4, each upsell item has an associated compensation that an employee may earn for offering the upsell, and an associated compensation that the employee may earn for completing the upsell (i.e., having a customer accept the upsell). For example, if the employee is prompted to offer the upsell designated by identifier UP-104713 (e.g., a large soda), he will earn $0.20 for offering the upsell. Then, if the customer accepts this upsell by agreeing to purchase the large soda, the employee will receive an additional $0.75 (or a total of $0.75). In some cases, employees may receive compensation for offering an upsell but not for completing the upsell, or vice-versa, as illustrated by record 86E where no compensation will be earned for offering the upsell designated by identifier UP-327025.

While the compensations in record 86A of compensation database 70 are static values which do not change (e.g., $0.20 for offering upsell UP-104713, an added $0.75 for completing the upsell), computer 22 can also determine or calculate dynamic compensations which change as described by a function. One method of determining a dynamic compensation involves calculating a result of a compensation function. A compensation function is a mathematical function used to calculate a compensation that may be provided to an employee. In one example, the compensation which may be earned is a function of the employee receiving a prompt and the value of an upsell:

compensation=f(employee_id,upsell_value) (1)

Other inputs to the compensation function may include other variables, such as the time of day, day of week, upsell item and historical data relating to paid compensations. As shown in FIG. 4, a different compensation function may be associated with each upsell, and different functions may be used for offering an upsell versus completing the upsell, or for other behaviors related to a particular upsell or related to upsells in general.

The output of a compensation function is a compensation which can take any of the forms described above. Thus, an output of a compensation function can be a monetary value, a number of points, or a good or service (e.g., a baseball hat). For example, a compensation function that uses an employee identifier and an upsell value as inputs can output information about a compensation that is in the form of points:

f(employee_id,upsell_value)=employee_multiplier*upsell_value (2)

In this example, each employee has an associated multiplier which may be based on his seniority, past performance, preferences and other factors. The output compensation is a number of points equal to the product of the employee multiplier and the upsell value.

In one embodiment of the invention, a compensation associated with an upsell can be modified by a person, computer 22 or another computer system. In one example, a manager uses input device 26 to generate signals which are received by computer 22, and cause computer 22 to change compensation database 70 such that the compensations associated with offering or completing a particular upsell depend on the signals. For more specific examples, a manager could use a database-editing program to modify the compensation associated with offering upsell UP-104713 from $0.20 to $0.30, to modify the compensation function associated with completing upsell UP-762345 by adding another variable, or to modify the method of determining compensations to provide all senior employees with an added 10% compensation for each upsell offer accepted. In another example, computer 22 could track the amount of inventory available, and modify the compensations associated with each upsell based on the amount of inventory (e.g., increasing compensations associated with upsells with excess inventory, and/or decreasing compensations associated with upsells with low inventory). The compensation amounts can also be modified based on input signals generated by, for example, a separate computer system which tracks the inventory.

In one embodiment, a compensation associated with offering or completing an upsell depends upon the likelihood that a customer will accept the upsell. For example, a compensation associated with an upsell that a customer is unlikely to accept (i.e., a “hard-to-sell upsell”) can be increased to provide added incentive for an employee to offer that upsell, and/or the compensation associated with an upsell likely to be accepted (i.e., an “easy-to-sell upsell”) can be decreased to prevent an employee from receiving a “windfall” for offering that upsell. The amount by which the compensation is increased or decreased based on the likelihood of customer acceptance can be a fixed amount (e.g., an additional $0.10 for offering a hard-to-sell upsell), a percentage of a normal compensation associated with the upsell (e.g., twice the normal compensation for offering the upsell), or can depend upon a measure of the likelihood of acceptance (e.g., an added $0.10 for offering an upsell accepted only 10% of the time; and an added $0.25 for offering an upsell accepted only 5% of the time). The amount that a compensation is modified can also be determined by a formula (e.g., a compensation associated with an upsell can be increased by $0.10 for each 5% that the customer acceptance rate falls below 25%). In each of these embodiments, the compensation that is offered to the employee can be subject to a maximum amount or a minimum floor (e.g., no more than $0.50, and/or no less than $0.05).

The likelihood that a customer will accept an upsell can be determined in several ways. The likelihood may be determined based upon historical customer acceptance rates (e.g., historical data may show that only 5% of prior customers accepted upsell offers for french fries), based upon how tenuous the relationship is between an upsell and the main purchase (e.g., a customer may be likely to accept an apple pie as an upsell when purchasing a meal, but may be unlikely to accept another entrée item when purchasing a meal), or based upon the discount at which the upsell is offered relative to its normal price (e.g., a customer may be likely to accept a french fries as an upsell for $0.10 of spare change, but may be unlikely to accept that same upsell for $0.65 of spare change). Another method for determining the likelihood of customer acceptance is to examine detailed sales histories for specific customers through the user of a customer loyalty or “frequent shopper” program (e.g., data from a “frequent shopper” program may show that this particular customer accepts upsells for french fries only 5% of the time). Under this scenario, the system may determine which customers are not likely to accept upsell offers in advance, and may increase the compensation offer to encourage the employee to try even harder for a positive result.

In one embodiment, computer 22 uses an artificial intelligence program (AIP) or a generic algorithm to determine a compensation method. Using the AIP or the generic algorithm, the computer analyzes any or all of the considerations and factors noted supra, such as historical data regarding employee performance, upsell offers, for example, success rates for the upsells, and operational parameters, for example, profit associated with upsells, for the business entity to determine an optimal compensation method.

In another embodiment, computer 22 uses a feedback algorithm, for example, an artificial intelligence program or a generic algorithm, to determine how and when to modify a compensation method. The feedback can be with respect to any of the compensation factors and means discussed supra. For example, the computer determines or receives information relating to the success rates of certain compensation methods, for example, correlating success with how an incentive to the employee is presented, how an employee executes an upsell, the success rate of upsells, or the relationship with operational factors such as check size or profit margin. The computer then uses this feedback information along with the feedback algorithm to determine how to modify the compensation method in the future. For example, the computer can be initialized to use the same compensation method for each employee, perhaps by providing each employee with $0.10 for offering each upsell. The POS terminals could then provide information to the computer relating to the number of upsells that are offered and the number accepted. If very few of the upsells are accepted, the computer could modify the compensation method so that each employee will now receive $0.20 for each upsell that is accepted, in addition to the $0.10 that each of the employee receives for offering the upsell. The compensation method could be still further modified based upon the results of this modification.

In another example of using a feedback algorithm, for example, an artificial intelligence program or a generic algorithm, to modify a compensation method, computer 22 may monitor a rate at which an employee makes upsell offers (i.e., the “offering rate”), or a rate at which customers accept the upsell offers (i.e., the “customer acceptance rate”). If the offering rate or customer acceptance rate is too low (e.g., falls below a threshold), computer 22 may determine that the compensation being offered is too low to sufficiently motivate the employee, and may increase the compensation being offered. Conversely, computer 22 may monitor the offering rate or customer acceptance rate to establish a baseline, and may decrease the amount of compensation being offered until detecting that the offering rate or customer acceptance rate begins to decrease. By using such feedback, computer 22 may determine the optimal compensations to offer in order to sufficiently motivate the employee without paying excessive compensation. Optimally, the system will only offer added compensation when necessary, and will not provide compensation (or will provide less compensation) when the likelihood of customer acceptance is otherwise high. Along with optimizing the compensation method for a single employee, feedback can be used to optimize the compensation method for an entire group of employees (e.g., an entire shift of employees at a quick-service restaurant), or for groups of stores within a franchise.

Further, feedback using a feedback algorithm, for example, an artificial intelligence program or a generic algorithm, can be used to modify or optimize a compensation process from the perspective of another parameter. For example, feedback can be used to optimize the compensations associated with a particular upsell, to optimize the prompt used to instruct employees on how to offer an upsell, to optimize the times when upsells are offered, or to optimize the determination of the upsell to be offered.

Historical factors that can be used to initially generate a compensation method using a feedback algorithm, for example, an artificial intelligence program or a generic algorithm, and information that can be monitored to modify a compensation method, using a feedback algorithm, for example, an artificial intelligence program or a generic algorithm, can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

Outputting Information about the Compensation

Once a compensation associated with an upsell is determined at step 14, computer 22 outputs information about the compensation at step 16. This information will typically be output to the employee, but may also be output to another person or people, such as the employee's manager or co-workers. The compensation information may be output using different types of output devices as output devices 32A, 32B, 32C in FIG. 2A, or 46A, 46B, 46C in FIG. 2B. Computer system 20 or 40 may use any combination of these output devices. The output devices may include a video display such as a CRT monitor, an LCD screen, or an LED screen. For example, an LCD screen on a POS terminal may display information indicating a compensation that will be earned for offering a certain upsell. The output device could also include an audio speaker such as a set of headphones, an earphone, a telephone, a public address system, a beeper, a pager, or a wearable computer equipped with an audio output. For example, an employee could wear an earphone that outputs a synthesized electronic voice that indicates the cumulative amount of compensation that he has earned so far on a given day. In another example, a bell could ring every time an employee earns 50 points. The output device could also include a printer such as a dot-matrix printer, a ribbon printer, an inkjet printer, a laser printer, or a thermal printer. For example, the POS terminal could include a ribbon printer for printing out a list of possible upsells which could be offered along with a customer's regular purchases, and their associated compensations, and the employee could then select an upsell from this list for presentation to the customer. The output device could also include a discrete output device having only two states, such as a light bulb on a POS terminal which may light up (outputting 1 bit of information) whenever an employee earns a compensation. Thus, the output device can have a simple structure.

In one embodiment, the output device is a private output device which is private to an employee, such that only the employee (and possibly his manager) receives the compensation information. For example, a pair of headphones is a private output device which allows only the employee wearing the headphones to hear the compensation information. In another embodiment, the output device is a public output device which is public to a group of people, such that the group receives the compensation information. For example, a public address system can be used to output compensation information to a group of employees, and can provide compensation information about a team of employees or a single employee (e.g., to announce that a certain employee achieved his monthly goal of successfully completing 3000 upsells). As another example, a video display visible to all of the employees could display the cumulative compensations of all the employees relative to each other, possibly in the form of a “race” around a track, with a different icon (e.g., a racecar, horse, etc.) being associated with each employee to show the progress of that employee relative to the others. Along with efficiently conveying information to the employees, this display would introduce entertainment into the system, possibly leading to improved morale.

Further, compensation information may be output to an employee using any of a variety of strategies, which can be referred to as “output strategies”. These output strategies include providing information about an incremental compensation, a cumulative compensation, a cumulative function of compensation, a past or future compensation, a compensation as part of a prompt, a compensation relative to a goal, or a compensation relative to another employee. The output strategy for the compensation information can be varied based on a parameter (e.g., over time), and additional information can be output along with the compensation information. Multiple output strategies can also be combined for use in outputting a single output. The compensation information can also be output in a graphical form (e.g., using a graphical pie chart to show an employee's progress towards earning enough compensation for a goal). Each of these output strategies is described in detail in the following paragraphs.

The compensation information can be output to an employee in incremental terms, with the incremental compensation information being associated with at least one behavior of the employee which is required to earn an incremental amount of compensation. Possible incremental compensations include an amount of compensation earned for offering an upsell, for successfully completing an upsell, or for performing a behavior associated with an upsell. For example, an employee could be informed that he will earn an incremental compensation of $0.20 for offering a medium french fries as an upsell. Outputting incremental compensation information can be particularly motivational to an employee due to the close nexus between the employee's behavior and the compensation (e.g., an incremental compensation can be associated with a single behavior), which may help to focus the employee's attention on the behavior needed to earn the incremental compensation. The incremental compensation information may be output shortly after the compensation is earned. For example, a POS terminal may indicate that an employee has just earned 10 points for offering a sundae as an upsell. The incremental compensation information may also be output shortly before the compensation is earned. For example, a POS terminal may indicate that an employee will earn 10 points for offering a sundae as an upsell. Thus, the employee can receive an indication of the compensation earned (or to be earned) in real-time (or in close to real-time) with respect to the time when his behavior should occur. The incremental compensation information may be output as part of a prompt. For example, a POS terminal may display a prompt to an employee, which includes both a behavior and an incremental compensation (e.g., “You will receive 10 points for offering a sundae to the customer.”). If the employee performs the behavior (i.e., offering the sundae), the employee will receive the compensation stated in the prompt (i.e., 10 points). The incremental compensation information can also be output relative to a goal, or relative to another employee(s). For example, a video screen may display a representation indicating that an employee just moved 10 points closer to his goal of earning a basketball, or a public address system could announce that Andy has moved 10 points closer to Bob—the employee who has earned the most cumulative points.

The compensation information can also be output to an employee in cumulative terms, with the cumulative compensation information being associated with a cumulative number of employee behaviors required to earn a cumulative amount of compensation. Examples of cumulative compensation include an amount of compensation earned during a certain period of time, earned during a certain number of transactions, or earned cumulatively by a group of employees. For example, an employee could be informed that he has earned a total compensation of $15 for offering 50 upsells during one shift. In one embodiment, a cumulative compensation is the sum of multiple incremental compensations. As with incremental compensation information, cumulative compensation information may be output shortly after the compensation is earned. For example, a POS terminal may indicate that an employee has earned 200 points during the last week by offering upsells. The cumulative compensation information may also be output just before the compensation is earned. For example, a POS terminal may indicate that an employee will have earned 200 points this week if he offers the customer a sundae. Thus, the indication about the cumulative compensation earned (or to be earned) is provided to the employee in real-time (or in close to real-time) with respect to when his behavior should occur. The cumulative compensation information may also be output as part of a prompt. For example, a POS terminal may display a prompt to an employee which includes both a behavior and a cumulative compensation (e.g., “You will have earned a total of 200 points if you offer this sundae to the customer”). If the employee performs the behavior (i.e., offering the sundae), the employee will earn the cumulative compensation stated in the prompt (i.e., 200 points). The cumulative compensation information can also be output relative to a goal, or relative to another employee(s). For example, a video screen may show a textual display indicating that an employee needs to earn only 50 more points to earn a basketball, or may show a graphical display (e.g., a pie chart) showing the employee's progress relative to the goal. For another example, a public address system could announce that Andy's point total is only 15 points behind Bob's point total, or that Andy has 1230 total points compared with Bob's 1245 total points.

The compensation information can also be output to an employee as a cumulative function of compensation. Possible cumulative functions of compensation include an average compensation earned over a period of time or over a number of transactions, or a result of a mathematical function such as mode, derivative or standard deviation of compensation. For example, an employee could be informed that he has earned an average of $25 each day during the past month due to behaviors associated with upsells, or has received an increase of $0.25 per hour for the pay period. As with incremental compensation information, cumulative function of compensation information can be output shortly after the compensation is earned. For example, a POS terminal may indicate that an employee has earned an average of 8.3 points per transaction over the last week. The cumulative function of compensation information may also be output shortly before the compensation is earned. For example, a POS terminal may indicate that an employee will have earned an average of 32 points per hour if he offers this customer a sundae. The cumulative function of compensation information may also be output as part of a prompt. For example, a POS terminal may display a prompt to an employee which includes both a behavior and a cumulative function of compensation (e.g., “You will have earned an average of 32 points per hour if you offer a sundae to the customer.”). If the employee performs the behavior (i.e., offering the sundae), he will receive the cumulative function of compensation (i.e., an average of 32 points per hour). The cumulative function of compensation can also be output relative to a goal, or relative to another employee(s). For example, a video screen may display a representation indicating that an employee needs to earn an average of 42 points per hour for the rest of the day in order to earn a basketball, or a public address system may announce that Andy is averaging 5 fewer transactions per hour than Bob, or that Andy is averaging 34 transactions per hour compared with Bob's average of 39 transactions per hour. The output information may be displayed in the form of a chart or graph to simplify the assimilation of information by the employee.

The compensation information can also be output to the employee as a past compensation which has already been earned by an employee. For example, an LCD screen may indicate that an employee has already earned 523 points during the past week. In this case, the outputting of the compensation information helps to inform the employee about his past performance. Thus, the employee is recognized for work that he has already performed, which may help to increase morale and motivate the employee to perform similarly in the future. Alternatively, the compensation information can be output as a future compensation which has not yet been earned by an employee. In one embodiment, an employee may only earn this compensation if he performs a particular behavior. For example, an employee may receive the following prompt which informs him of a future compensation: “If you cause this customer to accept an upsell of a medium french fries, you will earn 15 points.” Such information about a future compensation is likely to motivate the employee to perform a behavior in anticipation of the compensation that he will earn for performing that behavior.

As indicated above, compensation information can also be output to the employee as part of a prompt which includes both a behavior and a compensation. For example, a POS terminal could indicate that an employee will receive 10 points for offering a customer a large soda as an upsell for his $0.36 in spare change. The use of such real-time prompts may help employees to associate particular behaviors with the compensations provided for performing the behaviors. For another example, a textual or aural prompt could inform an employee that, “If you convince the customer to accept an upsell for a medium french fries, you will receive 15 points.” This example shows how compensation information output as part of a prompt may be described in incremental terms. The compensation information output as part of a prompt may also be described in cumulative terms. For example, a prompt may indicate, “If you convince this customer to round his total up to $5.00 in exchange for a toy, then you will have earned a total of 510 points.” A prompt may include information about a past compensation that has already been earned by the employee. For example, a prompt may indicate, “So far you have 235 points total; please offer the customer a salad in exchange for his $0.78 in spare change.” A prompt may also include information about a future compensation which has not yet been earned. For example, a prompt may indicate, “If you convince the customer to accept an upsell for a large sundae, then you will receive 10 points.” A prompt may describe a compensation relative to a goal, or relative to another employee(s). For example, a prompt may indicate, “If you offer the customer a hamburger for his $0.49 of spare change, you'll need only 35 more points to win a basketball”, or “You are only 15 points behind Bob. If you offer an apple pie as an upsell to this customer, you will have the 2nd most points of any of the employees.”

Also as indicated above, compensation information may be output to an employee relative to a goal. In one embodiment, a goal is described as a cumulative amount of compensation. For example, as shown in goal database 74 in FIG. 6, an employee may have a goal of earning a Chicago Bulls mini-basketball, requiring 1800 points. Other possible goals include a cumulative amount of compensation over time (e.g., 500 points earned in the next hour), a cumulative amount of compensation over a number of transactions (e.g., 500 points earned in the next 50 transactions), or a cumulative function of compensation (e.g., an average of 10 points earned per transaction). In one embodiment, employees earn compensation in the form of points, which are a form of alternate currency which may be exchanged for prizes (e.g., movie tickets, food or clothing). Compensation information may be output to an employee relative to one of the prizes. For example, an earphone may inform an employee, “You only need 65 more points to earn a new pair of basketball shoes.” In one embodiment, an employee is allowed to select his own goal. For example, an employee may actuate input device 30A, 30B, 30C to indicate that he has a goal of earning a $100 bonus, or of earning the 5000 points required to earn a new bicycle. In this case, the compensation information for the employee is displayed relative to the goal selected by the employee. The compensation information relative to a goal may be described in incremental terms. For example, an electronic voice may inform an employee, “By causing the customer to accept that upsell, you just earned 10 points towards a pack of baseball cards.” The compensation information relative to a goal may also be described in cumulative terms. For example, an employee may be told, “You need just 30 more points to win the employee-of-the-month award”, or “You're 80% of the way towards your day off this weekend; complete this upsell and you'll be 82% of the way there.” The compensation information relative to a goal may be described using a cumulative function. For example, an employee may be told, “On average, you need to complete the sale of 10 more upsells per hour to earn a new skateboard before Christmas.” Past compensation which has already been earned may be output relative to a goal. For example, an employee may be told, “Over the last week, you earned 50 points less than you needed to earn the employee-of-the-month award.” Future compensation which has not yet been earned may also be output relative to a goal. For example, an employee may be told, “If you average 10 upsells per hour for the rest of this shift, you'll earn a $20 pre-paid calling card.” A prompt may include compensation information relative to a goal. For example, an employee may be told, “Offer this customer a cookie for his $0.14 of change. If he accepts, you'll need just 20 more points to earn a plaque of recognition.”

Also as indicated above, compensation information may be output to an employee relative to another employee, or relative to a group of employees. This form of output may serve to foster a spirit of competition between employees, thereby motivating them to work harder in the hope of besting their fellow employees. For example, Andy and Bob may be rival employees, and Andy may be motivated to insure that he has more points than Bob. Compensation information relative to another employee may be described in incremental terms. For example, Andy may be told that he will move 5 points ahead of Bob if he offers a particular upsell. Compensation information relative to another employee may also be described in cumulative terms. For example, a public address system may announce that Andy is only 15 points behind Bob—the employee with the most cumulative points for the month, or that Andy has a total of 1230 points while Bob has a total of 1245 points. Compensation information relative to another employee may also be described in terms of a cumulative function of compensation. For example, Andy may be told, “If you average 10 points per transaction for the next two days, then you will have more points than Bob”, or that “Your average number of upsell offers per hour is 10% higher than Bob's average number of upsell offers per hour.” Past compensation which has already been earned may be output relative to another employee. For example, Andy may be told, “You have earned 15 points less than Bob.” Future compensation not yet earned may also be output relative to another employee. For example, Andy may be told, “If you convince the customer to accept this upsell, then you'll have only 15 points less than Bob.” Compensation information relative to another employee can also be included in a prompt. For example, Andy may be told, “Offer this customer a cookie if he'll round his total sale up to an even $4.00. Doing this will put you 15 points ahead of Bob.” A teamwork approach may also be implemented wherein employees must cooperate with each other for their team to earn compensations. This approach is likely to foster team spirit and may generate a positive level of peer pressure to ensure behavior compliance.

The output strategy may also provide information about a compensation provided as a potential payoff in a lottery or chance drawing. For example, upon completing an upsell, an employee could receive information indicating that the employee was immediately entered into a game of chance whose outcome is immediately known, or will be calculated at some later time. In either case, the information can inform the employee of his chance of winning the game in real time.

In one embodiment, first compensation information is output to a first employee using a first strategy which is independent of a second strategy by which second compensation information is output to a second employee. For example, Andy may see his compensation information described in incremental terms in a textual prompt on a video screen, while Bob may listen to his compensation information described in cumulative terms relative to a goal as output on an earphone. The strategy for outputting compensation information can be set independently for each employee. In this way, each employee can receive this information using a strategy which is the most motivational for him. For example, while Andy may be highly motivated by seeing his compensation information output in relationship to Bob's compensation, Bob may be more motivated to see his compensation information output relative to a goal. In one embodiment, each employee is permitted to select the strategy by which his compensation information is output by, for example, selecting from a menu of options using his input device 30A, 30B, 30C, or telling his selection to his manager for entry by the manager using input device 26. For example, an employee could select that he would prefer to receive information about his cumulative compensation relative to his goal of earning a free pair of movie tickets. The compensation information would then be output to the employee in accordance with the strategy selected by the employee.

In one embodiment, compensation information is output to an employee using one of a plurality of different strategies which is selected by computer 22 based upon a selection criteria. The selection criteria could include the day of week, or time of day. For example, if an employee is a football fan, he may be highly motivated by his progress toward earning a free football on weekends (when football is on television) but may be more motivated by his compensation relative to other employees during the week (when football is not being televised). In this case, different compensation information could be output to the employee based upon the day of the week. Other selection criteria which can be used by computer 22 (or by a manager) to select the strategy for outputting the compensation information to an employee include employee preferences, historical data, and the success or failure rate of previous output strategies.

The strategy used to output compensation information may also be selected as a function of a transaction rate for an employee, or group of employees. One reason for varying the strategy based on a transaction rate is that it takes time for an employee to view and respond to compensation information that is output to him. During periods of time when the transaction rate is high, compensation information can be output less often, or described in less detail, to help prevent the employee from spending too much time viewing this information. Alternatively, during relatively slow periods when the transaction rate is low, compensation information can be output more often, or described in more detail. For example, it may be appropriate to simply ring a bell whenever an employee successfully completes an upsell during times when the employee is very busy, while it may be appropriate to provide the employee with detailed information about his goal item or to allow the employee to browse through his historical compensation statistics when the employee is idle. Certain vendors may be willing to offset some or all of the cost of a goal item in exchange for the opportunity to take advantage of this targeted marketing to a specific employee or group of employees.

In the above example, the strategy for outputting the compensation information was selected as a function of a transaction rate. The output strategy could also be selected as a function of another variable, such as the amount of time that an employee spends viewing a prompt before making an upsell offer, the response time for a customer to respond to an upsell offer, a transaction level, or another variable. For example, assume that computer 22 measures 20 seconds elapsing between the time a prompt is output on an employee's POS terminal and the time the employee makes the prompted upsell offer. To shorten that 20-second time, computer 22 may adjust the output strategy to use, for example, a shorter prompt, or to provide a prompt in a graphical format that can be quickly scanned by the employee. Such a change may result in the viewing time being decreased from the 20 seconds down to only 5 seconds. The adjustments may be made manually by a manager or another system administrator (either within the establishment or remotely at a central location), or the system may be a self-tuning system that adjusts one or more variables itself to maximize performance. These variables may include the customer acceptance rate, overall service times, etc.

In one embodiment, computer 22 causes an employee's POS terminal to beep or display a message whenever that employee successfully completes an upsell, to make it clear which employee was successful. Alternatively, computer 22 could light a lamp associated with a particular employee (e.g., a lamp with the employee's name posted next to it) whenever that employee successfully completes an upsell. In another embodiment, computer 22 could ring a bell or provide another indication to all of the employees working a shift whenever any of them successfully complete an upsell, which may be particularly advantageous when the employees earn team compensations.

In one embodiment, computer 22 uses an AIP or a generic algorithm to determine how to output compensation information to an employee. Using the AIP or the generic algorithm, the computer analyzes any or all of the considerations and factors noted supra with respect to outputting the compensation information, such as historical data regarding employee performance with respect to the output, correlation of the output with upsell offers, for example, success rates for the upsells, and correlation of the output with operational parameters for the business entity, for example, profit associated with upsells, to determine an optimal method of outputting compensation information.

In another embodiment, computer 22 uses a feedback algorithm, for example, an artificial intelligence program or a generic algorithm, to determine how and when to modify a compensation method. For example, computer 22 monitors a result of outputting the compensation information to an employee using a first strategy, and then, using the AIP or the generic algorithm, adjusts the strategy based upon the monitored result, thereby using feedback to determine the adjusted strategy. For example, while outputting cumulative compensation information relative to a goal to an employee, computer 22 may monitor the success rate of this output strategy (e.g., by examining transaction records from the employee's POS terminal to determine the percentage of transactions wherein a customer accepts the employee's upsell offer). If this output strategy is unsuccessful (e.g., if the calculated percentage is low, such as less than 10%), computer 22 may adjust the output strategy (e.g., by switching to an output strategy of outputting incremental compensation information). This modification can then be repeated based on a result of the adjusted strategy.

In a more detailed example of using a feedback algorithm, for example, an artificial intelligence program or a generic algorithm, to adjust the output strategy, an employee operating a POS terminal indicates that his goal is to earn the 1000 points needed for a pair of free movie tickets, and compensation information is output to the employee as cumulative compensation relative to this goal. However, computer 22 determines that the employee does not seem to be well motivated since his customers are accepting upsells in only 10% of his transactions, or the computer determines the profits associated with the accepted upsells are too low. In response, using the feedback algorithm, computer 22 selects a new output strategy such as displaying the employee's cumulative compensation relative to other employees. This strategy proves to be more effective, as the employee's success rate increases to 30%, or the profits increase sufficiently. In this example, feedback is used to adjust the output strategy for outputting compensation information to an employee based upon a success rate of that employee or the profits associated with accepted upsells. Alternatively, the output strategy for an employee may be adjusted based on a success rate of another employee or a group of employees, or by another operational parameter, such as inventory reduction. Still further, feedback could be used to improve another behavior of the employee, such as to increase the rates at which the employee offers the upsell to his customers.

In one embodiment, computer 22 uses a feedback algorithm, for example, an artificial intelligence program or a generic algorithm, to adjust the strategy for outputting the compensation information until the strategy is determined to be “successful” (e.g., where the monitored customer acceptance rate exceeds a threshold, or profits associated with upsells exceed a threshold). In other embodiment, computer 22 continues to adjust the output strategy even where the current output strategy has been determined to be a success. Continuing to vary the output strategy can be beneficial because it keeps the output strategy from being predictable, helping to maintain employee interest, and because the new output strategies being attempted may prove to be even more motivational to the employees.

Historical factors that can be used to initially generate output of compensation information using a feedback algorithm, for example, an artificial intelligence program or a generic algorithm, and information that can be monitored to modify output of compensation information, using a feedback algorithm, for example, an artificial intelligence program or a generic algorithm, can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

Computer system 20 can also be used to output additional information to an employee in addition to the compensation information. In one embodiment, the information output to an employee can include a comment, criticism, suggestion, or encouragement from a manager, or from another employee. For example, the manager could use input device 26 to send a message to an employee stating, “You earned 500 more points this week than last week. Keep up the good work! Customers will accept more of your upsell offers if you smile more.” Similarly, computer system 20 could be used by an employee to send a message to his manager or to another employee, such as by sending the message: “What am I doing wrong? No one's accepting my offers.” The message may be input using a keyboard, touch screen, microphone or other device. In one embodiment, computer 22 uses a feedback algorithm, for example, an artificial intelligence program or a generic algorithm, to determine the additional information noted above or to modify the additional information.

Computer system 20 can also output additional information about an employee's performance. For example, an employee could use input device 30A, 30B, 30C (e.g., a keypad at his POS terminal) to access information about his performance statistics for the last month, including his total number of sales, average rate of offering upsells, average rate of customer acceptances of upsells, and the most common upsell items. Such information would then be displayed to the employee using output device 32A, 32B, 32C (e.g., by using the video screen of his POS terminal). In one embodiment, computer 22 uses a feedback algorithm, for example, an artificial intelligence program or a generic algorithm, to determine the additional information noted above, to modify the additional information, to determine presentation of the information, or to modify presentation of the information.

Computer system 20 can also output information about a task that needs to be performed by an employee. For example, information may be output to an employee indicating that he should take out the trash. In one embodiment, the employee could earn additional compensation for performing such a task. For example, an employee could be prompted, “If you take out the trash, you will receive 15 extra points.” The additional compensation would be earned upon computer system 20 receiving information indicating that the task has been completed (e.g., based upon an input signal provided to the system by the employee, or by the employee's manager). A computer system configured to output information about tasks to be performed by employees is described in the Applicants' U.S. Pat. Appl. No. 60/183,272, entitled “Downtime Instructions”, filed on Feb. 17, 2000, and incorporated herein by reference. In one embodiment, computer 22 uses a feedback algorithm, for example, an artificial intelligence program or a generic algorithm, to determine the task information noted above, to modify the information, to determine presentation of the information, or to modify presentation of the information.

In most of the examples above, compensation information is described as being output in the form of text or speech. However, compensation information may also be presented to employees in other forms, including graphically. For example, rather than outputting text to Andy that says, “You are 15 points behind Bob,” a video screen may be used to display a bar graph indicating the relative compensations of Andy and Bob. Other examples of graphical outputs include using a video screen to display the text of a prompt (e.g., “Offer the customer a sundae for his $0.23 of spare change.”) and a pie or bar graph showing how many points the employee has earned relative to his goal of earning free tickets to an amusement park, using a video screen to display a picture of the employee's goal item (e.g., an autographed basketball) and a line graph indicating the employee's progress toward achieving this goal, or using a video screen to display an animated picture of four race cars racing around a track, each car corresponding to a different employee, with the speed of each car corresponding to the rate at which each employee is causing customers to accept upsells, such that the car currently in the lead corresponds to the employee who has sold the most upsells. The use of graphical representations for outputting compensation information to employees is especially advantageous in situations where employees are very busy and do not have time to read text, or where employees may find it difficult to read, or to read English. In one embodiment, computer 22 uses a feedback algorithm, for example, an artificial intelligence program or a generic algorithm, to determine the output format noted above or to modify the output format.

Typically, compensation will be earned by an employee for performing a desired behavior related to an upsell (e.g., offering an upsell). However, compensation may also be earned for not performing an undesired behavior related to an upsell, or for a combination of performing a desired behavior and not performing an undesired behavior. For example, assume an employee of a quick-service restaurant has a success rate in completing upsells that is much lower than that of the average employee, and that the restaurant's manager believes (based on his observations of the employee) that the reason for the employee's low success rate is the employee's tendency to say “um” several times during each upsell offer. In this case, the employee could be prompted to make an upsell offer without saying “um” to earn a compensation (e.g., “Offer this customer an apple pie for his spare change without saying ‘um’, and you'll earn $0.25”). The employee will receive $0.25 if he both performs a desired behavior (i.e., offers the upsell) and does not perform an undesired behavior (i.e., does not say “um”). A voice-recognition circuit, or the manager, may determine if the employee said “um”, and may provide a signal for use in determining whether the compensation was earned.

In an alternative embodiment, employees receive penalties (i.e., “negative compensations”) for performing undesirable behaviors. An “undesirable behavior” may be an affirmative behavior that has been deemed by the employer to be undesirable (e.g., using the incorrect language to offer an upsell; offering the wrong upsell item; offering an upsell item at an incorrect or undesirable price), and may also include not performing a behavior (e.g., not making an upsell offer; not successfully completing an upsell; not meeting a goal associated with an upsell). In this embodiment, computer 22 is programmed to determine a penalty associated with an upsell. The amount of the penalty can be a fixed amount that does not depend upon the particular undesirable behavior (e.g., a loss of 10 points whenever any undesirable behavior is detected), or can be associated with a particular undesired behavior (e.g., a loss of 20 points for not making an upsell offer; a loss of all of the employee's points for not successfully completing at least five upsells during a shift). The penalty can be provided in different forms analogous to the forms by which positive compensations are provided. For example, an employee who does not make an upsell offer may suffer a penalty of losing 10 points, losing $0.25, or receiving a private or public reprimand.

In one embodiment, a customer can affect a compensation earned by an employee (or group of employees) by providing appropriate feedback. The feedback can include positive feedback where a customer is satisfied with an employee's performance, negative feedback where a customer is not satisfied with an employee's performance, or either positive or negative feedback. The positive or negative feedback information could be entered into computer system 20 by an employee's manager using input device 26 based upon comments made to the manager by a customer, or based upon the manager's observance of interactions between the employee and the customer. The feedback information could also be entered directly into the system by a customer using an appropriate customer input interface (e.g., positive and negative feedback input switches associated with an employee, such as switches provided within reach of the customer when the customer interacts with an employee operating a POS terminal, or switches located on a touch-screen enabled display or kiosk). In these embodiments, the employee receives a bonus for any positive feedback and is penalized for any negative feedback. For example, an employee could receive a bonus of 50 points where a customer provides feedback that the employee was courteous, or could lose all of his points where a customer indicates that the employee was very rude. In another embodiment, a first employee or a group of employees (and/or a customer) may provide feedback affecting the compensation that is earned by a second employee. In one embodiment, computer 22 uses a feedback algorithm, for example, an artificial intelligence program or a generic algorithm, to determine how to analyze and use the feedback to generate or modify a compensation method, or to generate or modify presentation of compensation information.

Other examples of penalties include team penalties, being assigned an additional item of work (i.e., an added work duty or an added amount of work time), or receiving a reprimand (e.g., private or public). The penalty can also be a personalized penalty which depends on the particular employee, and the penalty can be determined dynamically based on an input signal or a feedback algorithm. The penalty can also be determined by accessing a penalty database or rules database defining a correspondence between undesired behaviors and various penalties. Information about the penalty can be output to an employee (and possibly the employee's manager) in a manner similar to the output methods described above in relation to positive compensations. Further, the strategy by which the penalty information is output can be adjusted based on a monitored result, thereby introducing feedback into the determination of the penalty output strategy. Additional information can also be output to an employee along with the penalty information. For example, a prompt could be output to an employee which specifies a penalty associated with a particular undesired behavior that was performed by the employee, along with a suggestion for how that undesired behavior can be avoided in the future (e.g., “You lost 15 points because you did not offer the upsell to the last customer. Always look at the terminal's video screen to see the reminders.”).

In one embodiment, employees receive positive compensations in response to desired behaviors and negative compensations (i.e., penalties) in response to undesired behaviors. For example, an employee may earn 10 points if he offers a medium soda to a customer as an upsell, but may lose 15 points if he forgets to offer the upsell. Compensation information about a past penalty already assessed may be provided to an employee along with an indication of how that penalty can be earned back. For example, an employee could be informed that he just lost 15 points for not offering an upsell to a customer, but that he could earn those 15 points back by offering an upsell to each of the next five customers.

In another embodiment, employees receive only penalties. For example, an employee may start his shift with a predetermined number (e.g., 1000) of points. Then, during the course of his shift, he loses points for performing the wrong behaviors (e.g., not offering an upsell), or performing behaviors incorrectly (e.g., using the wrong words to offer an upsell). Compensation information may be displayed to the employee by displaying the total number of points he has left out of the original 1000 points. The employee's compensation could then depend on the final number of points left (e.g., he could earn a free movie ticket if he has at least 750 points left at the end of his shift).

In one embodiment, computer 22 uses a feedback algorithm, for example, an artificial intelligence program or a generic algorithm, to determine the undesirable behavior or the penalty noted above, to modify the undesirable behavior or the penalty, to determine presentation of the undesirable behavior or the penalty, or to modify presentation of the undesirable behavior or the penalty. In another embodiment, computer 22 uses a feedback algorithm, for example, an artificial intelligence program or a generic algorithm, to use the undesirable behavior or the penalty noted above to generate or modify a compensation method, or the generate or modify presentation of compensation information.

It is to be understood that, with certain exceptions, one or more of the output devices can be used together with one or more of the output strategies, and that any of these combinations of output devices and output strategies can be used with one or more of the compensation systems described above. Further, many of the output strategies discussed above can be used simultaneously. For example, incremental compensation information about a future compensation may be output graphically in the form of a prompt to an employee. Similarly, an employee may receive output information about both his incremental compensation and cumulative compensation. The various output devices and strategies may also be used to output compensation information to an employee's manager, or to others (e.g., the employee's co-workers).

### Alternative Embodiments of a Method for Motivating Employees

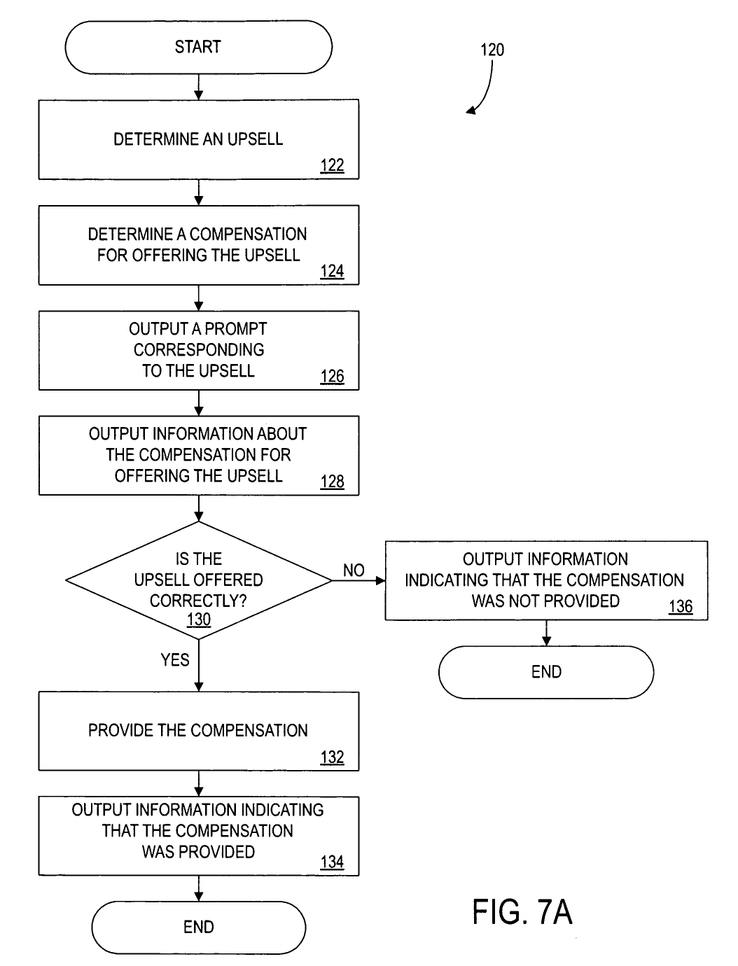

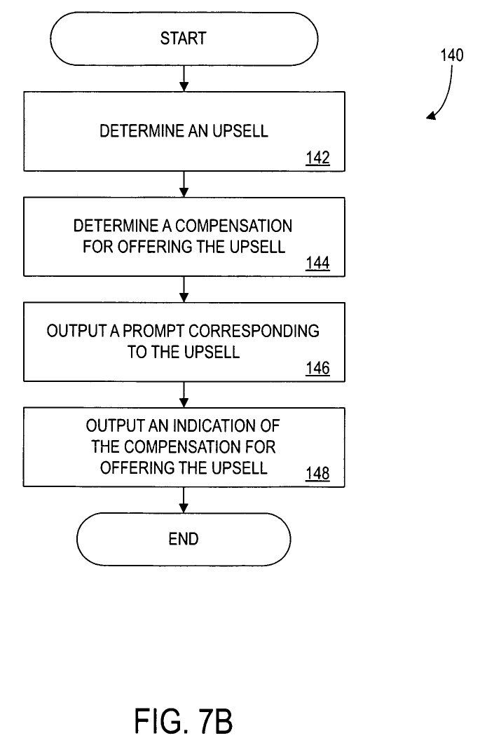

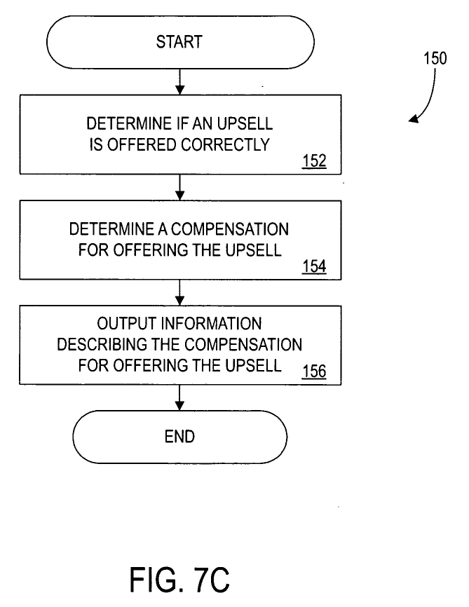

FIGS. 7A through 14 disclose alternative embodiments of a method for motivating employees according to the present invention. These embodiments are provided to illustrate the flexibility of the invention in adapting to different situations wherein a method for motivating employees is useful. It should be understood that still further embodiments of a method for motivating employees according to the present invention are contemplated by Applicants as being within the scope of their invention.

Referring to FIG. 7A, a method 120 for motivating an employee to perform a behavior related to an upsell includes outputting compensation information to an employee for offering an upsell, and providing the compensation if the upsell is offered correctly. At step 122, computer 22 determines an upsell (e.g., a medium french fries in exchange for the customer's spare change of $0.65), possibly using a method as disclosed in U.S. Pat. No. 6,119,099, entitled “Method and System for Processing Supplementary Product Sales at a Point-of-Sale Terminal”, issued on Sep. 12, 2000. At step 124, computer 22 determines a compensation for offering the upsell (e.g., 10 points), possibly by using a compensation database such as that shown in FIG. 4. At steps 126 and 128, computer 22 outputs a prompt corresponding to the upsell, and outputs information about the compensation for offering the upsell (e.g., by displaying a prompt on a video screen of the employee's POS terminal, “If you offer a medium french fries to the customer in exchange for his $0.65 of spare change, you will earn 10 points.”). At step 130, computer 22 determines if the upsell was offered correctly (e.g., using voice-recognition to analyze the verbal offer made by the employee), possibly using a method as described in U.S. Pat. No. 6,567,787 entitled “Method and Apparatus for Determining Whether a Verbal Message was Spoken During a Transaction at a Point-of-Sale Terminal”, issued on May 20, 2003. If the upsell was offered correctly, computer 22 provides the compensation to the employee at step 132 (e.g., by adding 10 points to the value stored in cumulative compensation field 94 in the record associated with the employee's identifier in employee database 72), and outputs information indicating that the compensation was provided at step 134 (e.g., by displaying, on the video screen, “Congratulations. You earned the 10 points.”). Alternatively, computer 22 outputs a message indicating that the compensation was earned but not yet provided (i.e., where another system actually provides the compensation). However, if the upsell was not offered, or was offered incorrectly, computer 22 outputs information indicating that the compensation was not provided at step 136 (e.g., by displaying, “You did not earn the 10 points since you did not offer the customer the french fries for his spare change.”).

In several embodiments discussed herein, voice-recognition technology is used to analyze the words spoken by an employee to determine if the correct words were spoken, and the analysis results are used to determine the compensation earned by the employee. In practice, an employee may dispute the outcome of this determination. In some cases, the employee may be correct (e.g., if the voice-recognition technology incorrectly analyzed the speech). In other cases, the employee may be incorrect (e.g., if the employee's actual spoken words differed from the words he thought he spoke). To resolve such disputes, one embodiment of the invention provides a switch (e.g., a “dispute” button on the employee's POS terminal) which can be actuated by the employee to indicate the existence of a dispute. Actuation of this “dispute” button can alert the employee's manager that a dispute has arisen, to allow the manager to resolve that dispute (e.g., by actuating a switch on his own terminal to indicate whether the employee should be compensated). For example, a manager may decide in favor of an employee if the manager observed that the words were spoken correctly, or determined the words were spoken correctly after listening to a recording. However, a manager may not always have the information needed to resolve such disputes, or may not always be available. Thus, actuation of the “dispute” button by an employee could also be used to “mark” the dispute. In response, computer 22 could resolve the dispute after accessing a transaction log for the employee's POS terminal to determine if the employee should be compensated. For example, computer 22 could determine that the employee should be compensated if the customer accepted the correct upsell. Alternatively, where the employee's POS terminal recorded the employee's speech, the “dispute” switch could mark the portion of recorded speech for re-analysis. The re-analysis of the recorded speech could then be performed by the computer (e.g., using a more sophisticated voice-analysis algorithm than used previously), or by being replayed to the employee's manager for a human re-analysis, with compensation provided based on the results of the re-analysis. Provision of a dispute resolution mechanism may help maintain employee confidence in the integrity and fairness of the compensation system. To discourage frivolous re-analysis requests from being made by employees, the employees could be penalized when it is discovered that the system was accurate, and could instead be paid extra compensation when a dispute is resolved in their favor.

Referring to FIG. 7B, a method 140 for motivating an employee to perform a behavior related to an upsell includes outputting a prompt corresponding to an upsell, and outputting an indication of a compensation to an employee for offering the upsell to a customer. At step 142, computer 22 determines an upsell (e.g., a medium french fries in exchange for the customer's change of $0.65). At step 144, computer 22 determines a compensation which may be earned for offering the upsell (e.g., 10 points). At steps 146 and 148, computer 22 outputs a prompt corresponding to the upsell, and outputs an indication of the compensation for offering the upsell (e.g., by displaying a prompt on a video screen of the employee's terminal, “If you offer a medium french fries to the customer for his $0.65 of change, you will earn 10 points.”). Method 140 thus includes steps similar to steps 122-128 of method 120 of FIG. 7A.

Referring to FIG. 7C, a method 150 for motivating an employee to perform a behavior related to an upsell includes outputting information to an employee describing a compensation for offering the upsell. At step 152, computer 22 determines if an upsell is offered correctly (e.g., using voice-recognition to analyze the offer made by the employee). At step 154, computer 22 determines a compensation for correctly offering the upsell (e.g., 10 points). At step 156, computer 22 outputs information describing the compensation for correctly offering the upsell (e.g., by displaying a prompt on the employee's terminal, “For correctly making that offer, you just earned 10 points.”). Method 150 thus includes steps similar to steps 130-134 of method 120 of FIG. 7A. Thus, method 120 of FIG. 7A includes steps similar to method 140 in FIG. 7B followed by steps similar to method 150 in FIG. 7C, illustrating that a method in accordance with the present invention can be executed repeatedly in sequence.

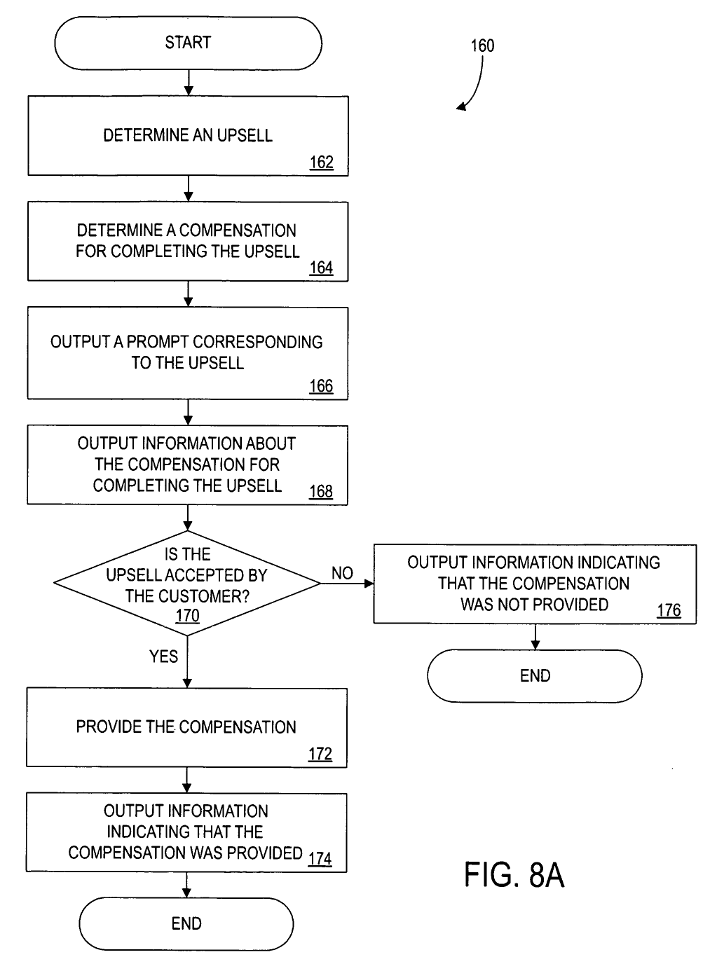

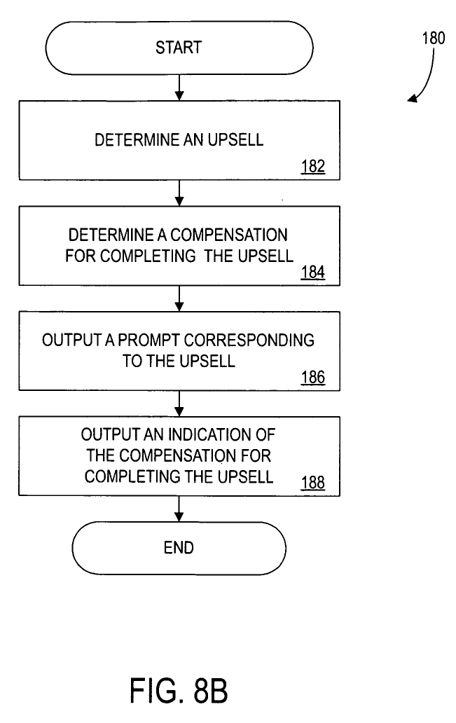

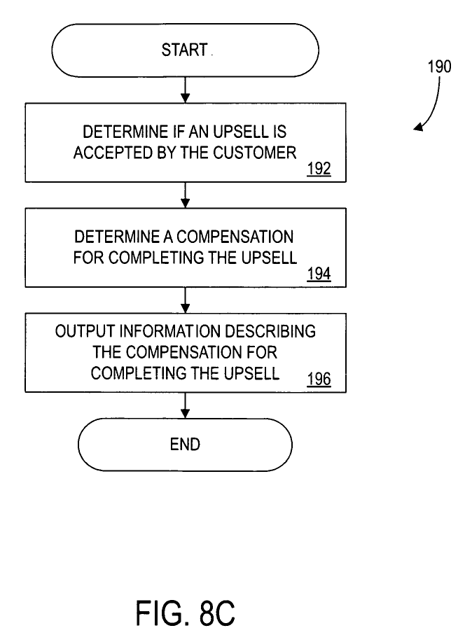

FIGS. 8A, 8B and 8C are similar to FIGS. 7A, 7B and 7C, except that FIGS. 8A, 8B and 8C refer to a compensation that may be earned for completing an upsell (i.e., having the customer accept the upsell), while FIGS. 7A, 7B and 7C refer to a compensation that may be earned just for offering an upsell to the customer.

Referring to FIG. 8A, a method 160 for motivating an employee to perform a behavior related to an upsell includes outputting compensation information to an employee for completing the upsell, and providing the compensation if the upsell is accepted. At step 162, computer 22 determines an upsell (e.g., a medium french fries in exchange for the customer's change of $0.65). At step 164, computer 22 determines a compensation for completing this upsell (e.g., 25 points), possibly by using a compensation database such as that shown in FIG. 4. At steps 166 and 168, computer 22 outputs a prompt corresponding to the upsell, and outputs information about the compensation for completing this upsell (e.g., by displaying a prompt on a video screen of the employee's POS terminal, “If you convince the customer to accept a medium french fries in exchange for his $0.65 of change, you will earn 25 points.”). At step 170, computer 22 determines if the upsell was accepted by the customer (e.g., based on a signal received from a keypad actuated by the employee). If the upsell was accepted, computer 22 credits the compensation to the employee at step 172 (e.g., by adding 25 points to the value stored in cumulative compensation field 94 in the record associated with the employee's identifier in employee database 72), and outputs information indicating that the compensation was credited at step 174 (e.g., by displaying, on the video screen, “Congratulations. You earned the 25 points.”). If, however, the upsell was not accepted, computer 22 outputs information indicating that the compensation was not credited at step 176 (e.g., by displaying, “You did not earn the 25 points.”).

Referring to FIG. 8B, a method 180 for motivating an employee to perform a behavior related to an upsell includes outputting a prompt corresponding to an upsell, and outputting an indication of a compensation to an employee for completing the upsell. At step 182, computer 22 determines an upsell (e.g., a medium french fries in exchange for the customer's spare change of $0.65). At step 184, computer 22 determines a compensation for completing the upsell (e.g., 25 points). At steps 186 and 188, computer 22 outputs a prompt corresponding to the upsell, and outputs an indication of the compensation for completing the upsell (e.g., by displaying, on a screen of the employee's terminal, “If the customer accepts an upsell offer of a medium french fries in exchange for his $0.65 of spare change, you will earn 25 points.”). Method 180 thus includes steps similar to steps 162-168 of method 160.

Referring to FIG. 8C, a method 190 for motivating an employee to perform a behavior related to an upsell includes outputting information to an employee describing a compensation for completing the upsell. At step 192, computer 22 determines whether an upsell is accepted by the customer. At step 194, computer 22 determines a compensation for completing this upsell (e.g., 25 points). At step 196, computer 22 outputs information describing the compensation for completing the upsell (e.g., by displaying a prompt on the employee's terminal, “You just earned 25 points.”).

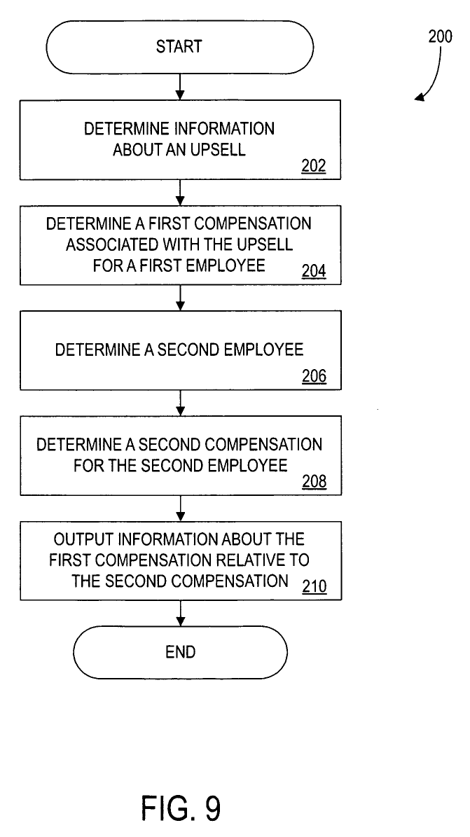

Referring to FIG. 9, a method 200 for motivating an employee to perform a behavior related to an upsell includes outputting compensation information relative to another employee. At step 202, computer 22 determines information about an upsell (e.g., a medium french fries in exchange for the customer's change of $0.65). At step 204, computer 22 determines a first compensation associated with the upsell for a first employee (e.g., 10 points for offering the upsell), possibly by accessing a compensation database such as database 70 in FIG. 4. At step 206, computer 22 determines a second employee, possibly by accessing information about the first employee stored in employee database 72 in FIG. 5 (e.g., if the first employee is Jim Daniels, who has employee identifier EMP-082-078542, then the second employee is John Beam, who has employee identifier EMP-205-237852, as indicated by preferred output strategy field 98). At step 208, computer 22 determines a second compensation belonging to the second employee (e.g., John Beam has a cumulative compensation of 988 points). Then, at step 210, computer 22 outputs information about the first compensation relative to the second compensation (e.g., since the incremental compensation of 10 points would raise Jim Daniels' cumulative compensation from 983 to 993 points, and John Beam has 988 points, a prompt is output stating, “If you offer a medium french fries to the customer, you will then have 5 more points than John has.”).

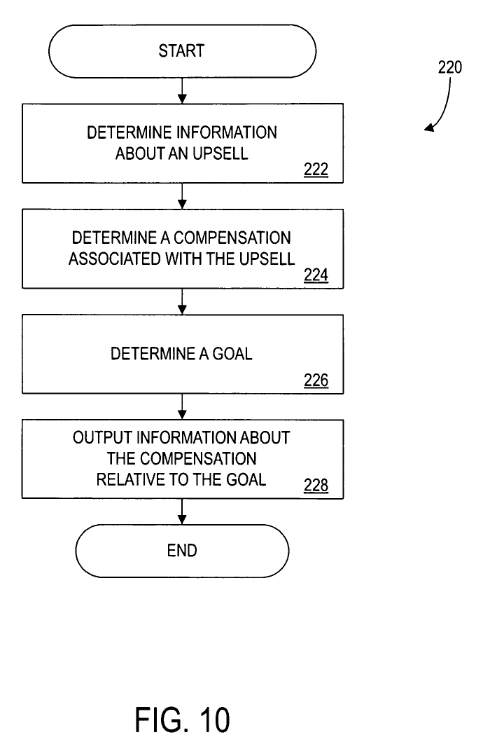

Referring to FIG. 10, a method 220 for motivating an employee to perform a behavior related to an upsell includes outputting compensation information relative to a goal. At step 222, computer 22 determines information about an upsell (e.g., a medium french fries in exchange for the customer's change of $0.65). At step 224, computer 22 determines a compensation associated with the upsell (e.g., 50 points for both offering this upsell correctly and completing this upsell). At step 226, computer 22 determines a goal, possibly by accessing information stored in employee database 72 and goal database 74 (e.g., preferred output strategy field 98 of employee database 72 indicates that Jeff Lee, employee no. EMP-205-082345, prefers to have his compensation information output as cumulative points relative to goal G-23408, and goal database 74 indicates that goal G-23408 is a Chicago Bulls mini-basketball which requires a total of 1800 points). At step 228, computer 22 outputs information about the compensation relative to the goal (e.g., after adding the compensation of 50 points for correctly offering the upsell to Jeff's cumulative compensation of 1700 points, computer 22 outputs: “If you correctly offer a medium french fries to the customer in exchange for his spare change of $0.65, and get him to accept the upsell, you will then be only 50 points away from earning a free Chicago Bulls mini-basketball.”).

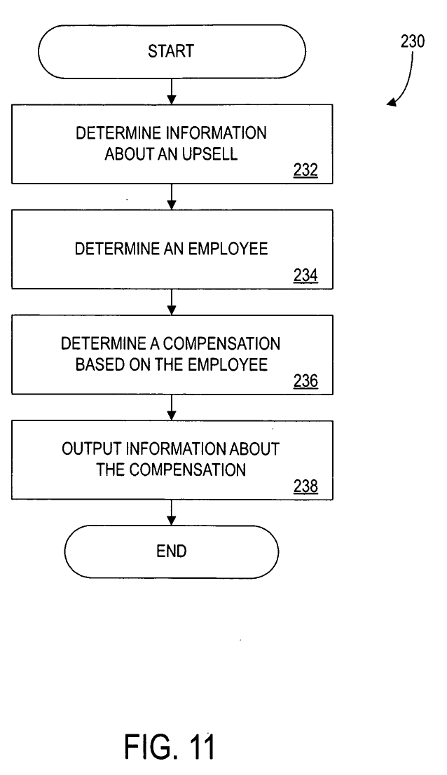

Referring to FIG. 11, a method 230 for motivating an employee to perform a behavior related to an upsell includes outputting compensation information personalized to the employee. At step 232, computer 22 determines information about an upsell (e.g., a medium french fries in exchange for the customer's change of $0.65). At step 234, computer 22 determines an employee, possibly by determining the identifier for the employee from employee database 72 using the employee's name which was entered into computer system 20 by the employee at the start of his shift, or by the employee's manager. At step 236, computer 22 determines a compensation based on the employee, possibly by using the employee identifier as an index into employee database 72 (e.g., if the employee is a new hire, he could receive double the normal compensation stored in compensation database 70 until he earns his first goal, thereby helping to encourage him to learn the system while he is being trained). At step 238, computer 22 outputs information about the compensation to the employee.

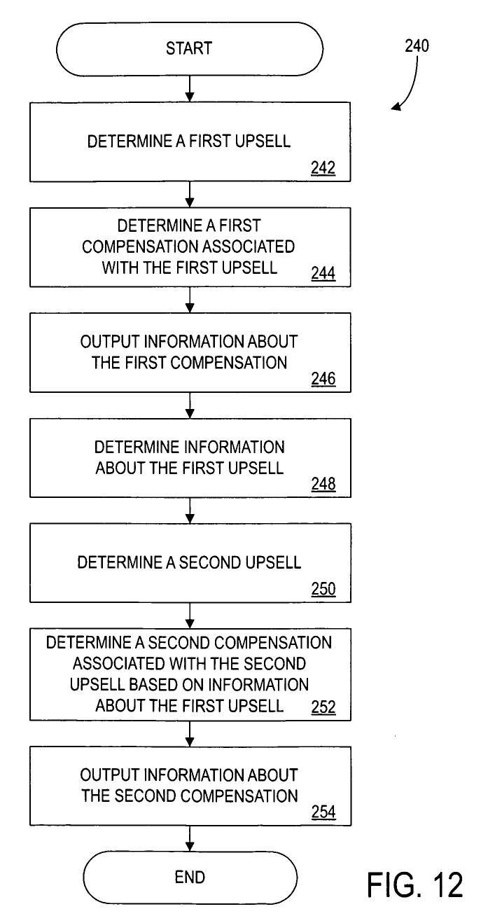

Referring to FIG. 12, a method 240 for motivating an employee to perform a behavior related to an upsell includes using an AIP or a generic algorithm to determine or modify a compensation to be provided to the employee. At step 242, computer 22 determines a first upsell (e.g., a medium french fries in exchange for the customer's spare change of $0.65). At step 244, computer 22 determines a first compensation associated with the first upsell (e.g., 25 points for completing the upsell). In one embodiment, computer 22 uses the AIP or a generic algorithm to determine the first compensation. At step 246, computer 22 outputs information about the first compensation to the employee (e.g., “You will earn 25 points if the customer accepts a medium french fries as an upsell.”). In one embodiment, computer 22 uses the an AIP or a generic algorithm to determine the information or an output of the information. At step 248, computer 22 determines information about the first upsell (e.g., did the customer accept the medium french fries?). At step 250, computer 22 determines a second upsell (e.g., if the customer rejected the medium french fries, offer a milkshake in exchange for the customer's spare change of $0.65). At step 252, computer 22 determines a second compensation associated with the second upsell based on information about the first upsell (e.g., if the customer rejected the first upsell, provide the employee with double the normal amount of compensation if the customer accepts the second upsell). In one embodiment, computer 22 uses the an AIP or a generic algorithm to determine the second compensation. At step 254, computer 22 outputs information about the second compensation (e.g., “You will earn 50 points if the customer accepts a milkshake as an upsell.”). In one embodiment, computer 22 uses an AIP or a generic algorithm to determine the information or an output of the information. Thus, the second compensation is determined using feedback about the results of the first upsell attempt. In this example, it is possible that the customer may be disposed to reject any upsell offer. Thus, the employee may be more richly rewarded if he can convince the customer to overcome this disposition. (Instead of prompting the employee to offer the second upsell when the first upsell offer was rejected, the employee could also be prompted, “Ask the customer if he's sure”.) In method 240, feedback is used to modify the second compensation based upon information about a result of the first upsell.

In certain embodiments of the invention, it may become advantageous to modify the compensation system to prevent employees from manipulating the system. For example, in the prior example, it may be possible for an employee to manipulate the system by intentionally speaking a first upsell offer in a way that makes it unlikely that a customer will accept (e.g., by mumbling the offer so that the customer will have a difficult time hearing the offer), and then speaking a second upsell offer in a way that makes it more likely that the customer will accept (e.g., by clearly annunciating the offer) in the hopes of earning the enhanced compensation of 50 points. To handle this situation, computer 22 may be programmed to prevent manipulation by, for example, using feedback to adjust a compensation based only upon the results of multiple transactions or multiple employees. Elements of randomness or pseudo-randomness may also be employed to prevent employees from learning to manipulate the system.

In one embodiment, computer 22 uses a feedback algorithm, for example, an artificial intelligence program or a generic algorithm, to prevent manipulation by the employee. Using the AIP or the generic algorithm, the computer analyzes any or all of the considerations and factors noted supra, such as historical data regarding employee performance, upsell offers, for example, success rates for the upsells, and operational parameters, for example, profit associated with upsells, for the business entity to determine an optimal compensation method, to modify the compensation method, to determine a presentation of compensation information, or to modify the presentation of compensation information so as to minimize employee manipulation.

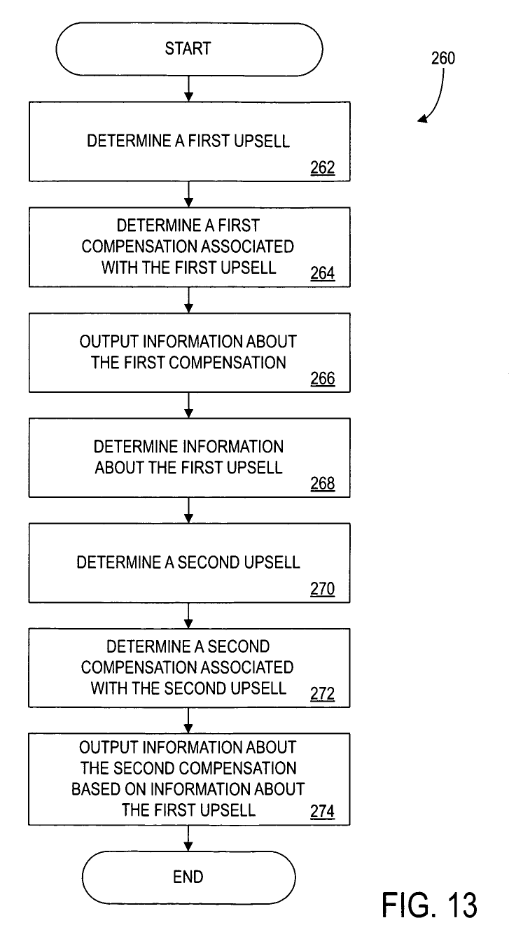

Referring to FIG. 13, a method 260 for motivating an employee to perform a behavior related to an upsell includes using an AIP or a generic algorithm to determine or modify an output strategy for indicating compensation information to the employee. At step 262, computer 22 determines a first upsell (e.g., a medium french fries in exchange for the customer's change of $0.65). At step 264, computer 22 determines a first compensation associated with the first upsell (e.g., 10 points for offering the upsell). In one embodiment, computer 22 uses the AIP or a generic algorithm to determine the first compensation. At step 266, computer 22 outputs information about the first compensation using a first output strategy (e.g., output the compensation information according to the output strategy selected by the employee). In one embodiment, computer 22 uses the AIP or a generic algorithm to determine the first output strategy. At step 268, computer 22 analyzes information about the first upsell (e.g., acceptance of the first upsell). In one embodiment, computer 22 uses the AIP or a generic algorithm to analyze the information. At step 270, computer 22 determines a second upsell (e.g., a milkshake in exchange for the next customer's spare change of $0.39). At step 272, computer 22 determines a second compensation associated with the second upsell (e.g., 15 points for offering the second upsell). In one embodiment, computer 22 uses the AIP or a generic algorithm to determine the second compensation. At step 274, computer 22 outputs information about the second compensation using a second output strategy based on information about the first upsell (e.g., if the first upsell was rejected, output the second compensation information relative to another employee). In one embodiment, computer 22 uses the AIP or a generic algorithm to determine the second output strategy. In the steps above, feedback is used to modify the strategy for outputting the compensation information, to optimize employee motivation.

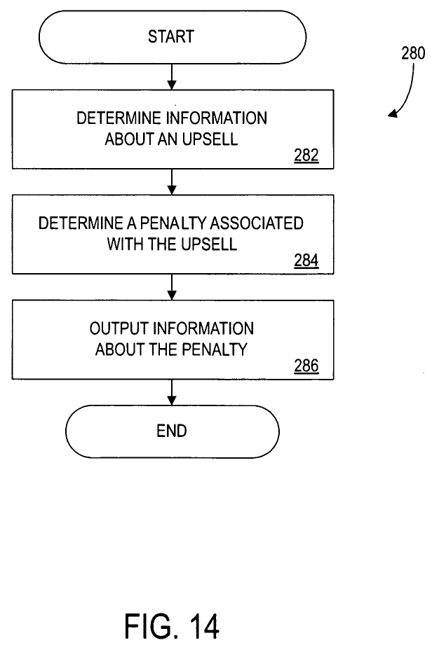

Referring to FIG. 14, a method 280 for motivating an employee to perform a behavior related to an upsell includes determining a penalty that may be applied to the employee for behaving in an undesired manner, and then outputting information about this penalty to the employee. At step 282, computer 22 determines information about an upsell (e.g., a medium french fries in exchange for the customer's spare change of $0.65). At step 284, computer 22 determines a penalty based on the employee's behavior associated with the upsell (e.g., subtract 10 points from the employee's cumulative compensation for not offering the upsell to the customer). In one embodiment, computer 22 uses an AIP or a generic algorithm to determine the penalty. At step 286, computer 22 outputs information about the penalty to the employee (e.g., “You lost 10 points for not offering the french fries as an upsell to the customer.”). In one embodiment, computer 22 uses an AIP or a generic algorithm to determine how to present the penalty.

In another embodiment, each POS terminal 24A, 24B, 24C is part of a POS network that may include a large number of POS terminals located in a number of different locations. When an employee at a first POS location performs a new behavior related to an upsell, the performance of that behavior is evaluated at that location (e.g., did the customer accept the upsell offer?). Based on this evaluation, the new behavior may be applied, at least in part, to a second POS location (which may have been selected due to a demographic or geographic similarity to the first POS location). This process may be repeated indefinitely so as to propagate successful new behaviors to other parts of the POS network. As a new behavior propagates, the POS network tracks the value of the new behavior to the company that owns or operates the POS terminals, and the employee who originated the behavior is rewarded accordingly. Thus, the POS network operates as a feedback mechanism which determines how to optimize compensation for its employees to motivate them to perform successful new behaviors related to upsells. Information about propagating information across a POS network is disclosed in commonly-owned and co-pending U.S. Pat. Appl. No. 60/150,630, entitled “Method and Apparatus for Propagating Promotions in a Point-of-Sale Network”, filed on Aug. 25, 1999, and incorporated herein by reference. The POS network can also monitor the interactions between employees and customers, and can “learn” which of the employees' behaviors lead to successful results (e.g., accepted upsell offers), using techniques similar to those disclosed in commonly-owned and co-pending U.S. Pat. Appl. No. 60/183,993, entitled “Systems and Methods for Determining a Customer-Employee Interaction Rule”, filed Feb. 22, 2000, incorporated herein by reference.

In one embodiment, computer 22 uses an AIP or a generic algorithm to determine and execute the propagation in the POS network as described supra. In another embodiment, computer 22 uses a feedback algorithm, for example, an AIP or a generic algorithm, to execute the feedback operations noted supra.

The interactions between the employee and customer discussed herein may take place with the employee and customer on opposite sides of a POS terminal. This interaction may also occur in other situations. For example, a customer may speak his order into a microphone placed near his automobile in a drive-through lane of a quick-service restaurant, and an employee within the restaurant who hears the order via a speaker or headset may then make an upsell offer to the customer via his own microphone. For another example, a customer may place his order remotely using a PDA, wireless telephone, computer coupled to a communications link, etc., and an employee within the restaurant may receive the order and send back an upsell offer. Remote ordering methods are disclosed in commonly-owned and co-pending U.S. patent application Ser. No. 09/222,381, entitled “Method and Apparatus for Remote Order and Pickup”, filed Dec. 29, 1998; and commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008, incorporated herein by reference. In each of these situations, the methods and systems disclosed herein could be used to motivate the employee to perform a behavior related to an upsell (e.g., offer an upsell to a customer).

Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the operation of computer 22 using an AIP or generic algorithm, for example, using an AIP to generate or modify a compensation method.

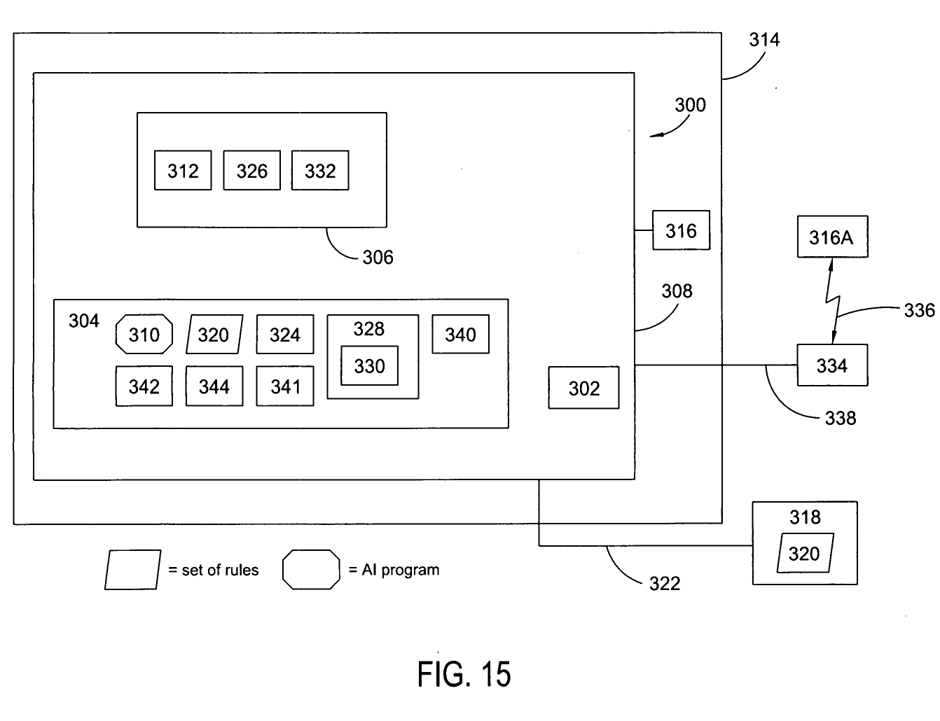

FIG. 15 is a schematic block diagram of present invention system 300 for providing an employee incentive. As further described infra, system 300 operates to use artificial intelligence to inform or make the decisions discussed supra, for example, in the descriptions for FIGS. 1 through 14. Thus, the preceding discussions are generally relevant to system 300, for example, as regarding the objectives of an incentive, business operations relevant to determining and implementing an incentive, and factors regarding the employee to whom the incentive is directed.

System 300 includes interface element 302, memory unit 304, and processor 306 in at least one specially programmed general-purpose computer 308. The processor is for, that is, the processor generates, using artificial intelligence program (AIP) 310 in the memory unit, incentive 312 for at least one employee (not shown) of a business entity, for example, a business entity owning or operating location 314, to perform at least one desired operation (not shown). Incentive 312 is analogous to the compensation method for an employee discussed infra. The processor also transmits, using the interface element, the incentive for display on display device 316. The incentive can be any incentive known in the art. The discussion in the descriptions of FIGS. 1 through 14 regarding compensation methods is applicable to incentives that can be generated by system 300, but does not limit the incentives that can be generated by system 300.

By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. Processor 306 and interface element 302 can be any processor or interface element, respectively, or combination thereof, known in the art.

Computer 308 can be any computer or plurality of computers known in the art. In one embodiment, the computer is located in a retail location with which system 300 is associated, for example, location 314. In another embodiment (not shown), all or parts of the computer are remote from retail locations with which system 300 is associated. In a further embodiment, computer 308 is associated with a plurality of retail locations with which system 300 is associated. Thus, the computer provides the functionality described for more than one retail location.

In one embodiment, computer 318, separate from computer 308, transmits modifying rule 320 to computer 308. Computer 318 can be in location 314 (not shown) or can be in a different location. Computer 318 can be associated with a business entity associated with location 314 or can be associated with a different business entity. Connection 322 between computers 308 and 318 is any type known in the art. In another embodiment (not shown), multiple computers 318 are included and respective computers among the multiple computers can be associated with the same or different business entities. Computer 308 stores modifying rule 320 in memory 304. The processor modifies incentive 312 using rule 320. Rule 320 can be related to any aspect, described supra, regarding an employee compensation or incentive. Computer 318 generates rule 320, and the processor modifies the incentive, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, data 324 regarding operation of the business entity is stored in the memory unit and the processor uses the data to generate or modify the incentive as further described infra. In another embodiment, the processor generates, using data 324 and AIP 310, desired outcome 326 for the first business entity and uses the desired outcome as part of generating or modifying the incentive. The desired outcome could be optimization of one or any combination of the factors, described supra and infra, related to operation of a business entity, for example, maximizing check size or profit, or reducing inventory loss. Data 324 can be related to any of the factors, noted supra and infra, related to operation of a business entity.

In one embodiment, data 328 regarding the at least one employee is stored in the memory unit and the processor uses data 328 and the AIP to generate or modify the incentive. In another embodiment, data 328 includes historical information 330 regarding performance of the at least one employee with respect to the business entity. In a further embodiment, the processor generates, using data 328 and the AIP, desired outcome 332 for the at least one employee and uses the desired outcome for the at least one employee along with the AIP to generate or modify the incentive. Data 328 can be any of the factors, noted supra and infra, related to an employee or the performance of an employee. In yet another embodiment, the at least one desired operation includes the at least one employee presenting an offer, for example, an offer for an additional item as described in commonly-owned U.S. patent application Ser. No. 12/151/040: “METHOD AND SYSTEM FOR MANAGING TRANSACTIONS INITIATED VIA A WIRELESS COMMUNICATIONS DEVICE,” inventors Otto et al., filed May 2, 2008; commonly-owned U.S. patent application Ser. No. 12/151/042: “METHOD AND SYSTEM FOR GENERATING AN OFFER AND TRANSMITTING THE OFFER TO A WIRELESS COMMUNICATIONS DEVICE,” inventors Otto et al., filed May 2, 2008; commonly-owned U.S. patent application Ser. No. titled: “METHOD AND SYSTEM FOR GENERATING A REAL TIME OFFER OR A DEFERRED OFFER,” inventors Otto et al., filed Jul. 7, 2008; commonly-owned U.S. patent application Ser. No. titled: “METHOD AND APPARATUS FOR GENERATING AND TRANSMITTING AN IDEAL ORDER OFFER,” inventors Otto et al., filed Jul. 7, 2008; commonly-owned U.S. patent application Ser. No. titled: “SYSTEM AND METHOD FOR GENERATING AND TRANSMITTING LOCATION BASED PROMOTIONAL OFFER REMINDERS,” inventors Otto et al., filed Jul. 7, 2008; or, commonly-owned U.S. patent application Ser. No. titled: “SYSTEM AND METHOD FOR LOCATION BASED SUGGESTIVE SELLING,” inventors Otto et al., filed Jul. 7, 2008.

In one embodiment, data 330 includes, but is not limited to: data regarding previous compliance of the at least one employee with respect to presenting previous upsell offers; or data regarding financial considerations, with respect to the business entity, of upsell offers previously available for presentation by the at least one employee. The compliance data can include, but is not limited to, a percentage of upsells actually presented by the employee with respect to a number of upsells that were available for the employee to present or the acceptance rate of upsells presented by the employee. Financial considerations can include any of the parameters or factors described supra or infra that impact the finances of the business entity, for example, check size, net or gross profit, or inventory reduction. For example, the data regarding financial considerations, with respect to the business entity, of upsell offers previously available for presentation by the at least one employee can include, but is not limited to, check size, net or gross profit, or inventory reduction associated with upsell offers previously available for presentation by the at least one employee. In another embodiment, the financial considerations are with respect to upsells presented by the employee and accepted by customers. In a further embodiment, the processor uses data 330 and the AIP to generate or modify the incentive.

Display device 316 can be any display device known in the art. In one embodiment, display device is a point of sales station, for example, a cash register, at which the employee is working. In another embodiment, a customer places an order from a location remote from the location for the business entity, for example, location 314, using any means known in the art, for example, a remote kiosk (not shown) or wireless communications device (WCD) 316A. WCD 316A can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to orders received from the WCD.

In one embodiment, WCD 316A is owned by, leased by, or otherwise already in possession of an end user when system 300 interfaces with the WCD. In the description that follows, it is assumed that the WCD is owned by, leased by, or otherwise already in possession of the end user when system 300 interfaces with the WCD. In general, the WCD communicates with a network, for example, network 334, via radio-frequency connection 336. Network 334 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 334 using any means known in the art, including, but not limited to a hardwire connection, an optical connection, an Internet connection, or a radio frequency connection. In the figures, a non-limiting example of a hardwire connection 338 is shown. In one embodiment, device 316A is connectable to a docking station (not shown) to further enable communication between device 316A and system 300. Any docking station or docking means known in the art can be used. That is, when the device is connected to the docking station, a link is established between the device and system 300.

In general, system 300, and in particular, the processor using the AI program, operates to use artificial intelligence, for example, a generic algorithm, to inform or make the decisions discussed in the descriptions for FIGS. 1 through 14. In one embodiment, system 300 uses one or all of data 324, 328, or 330, to generate the incentive to attain or maximize an objective of the business entity, for example, desired outcome 326. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

In one embodiment, the incentive also is generated to attain or maximize an objective for the at least one employee, for example, desired outcome 332. The discussion supra regarding the generation and modification of compensation methods is applicable to the following descriptions of determinations made by the processor or operations performed by the processor as part of generating the incentive using the AI program. It should be understood that the following are examples only and that the scope of system 300 is not limited to these examples. Further, it should be understood that system 300 can perform none, any, or all of the following operations at any particular time.

The system can determine the type of incentive to generate, the compensation structure of the incentive, for example, size of a cash bonus associated with satisfactory execution of a desired operation, such as presenting an upsell offer, the frequency with which an incentive is presented, when an incentive is presented, in which locations an incentive is presented, and how the incentive is presented. The system also can determine the frequency with which the compensation structure is presented to the employee, when the compensation structure is presented, in which employee locations the compensation structure is presented, and how the compensation structure is presented.

The system can determine the compensation structure, and hence the hoped for compliance of the employee with the desired operation, to optimize a parameter associated with operation of the business entity, for example, desired outcome 326. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007, describe factors associated with optimizing a business operation. The desired outcome can include, but is not limited to the following with respect to the business entity or location 314: profit, size of the average check, transaction count, upsells accepted, or any combination of factors.

In one embodiment, the system groups employees according to parameters, such as parameters related to the desired behavior. For example, the parameters could include, but are not limited to POS station usage, presentation of an upsell offer, percentage of accepted upsell offers, or profit (or other operational parameter) associated with accepted upsell offers. The group parameters are applied to employees and the employees are placed in respective groups according to the convergence of employee parameters with the group parameters. For example, one cashier behaves like a group of other cashiers based on POS usage and other metrics and the system provides similar incentive systems the cashier and the group of cashiers. Thus, compensation structures are generated for each of the groups and the members of the group are compensated according to the structure of the group to which they belong. In another embodiment, the processor uses the AIP to perform some or all of the grouping operations.

In one embodiment, the system determines compensation type for an employee or an employee group. For example, the compensation can be monetary or points in a reward system. In another embodiment, the system determines how to display the awarding of a compensation, for example, by flashing a light or via a graphical user interface (GUI). In a further embodiment, the system determines goals for each employee, for example, percentage of upsell acceptances to attain a reward, or performance that will alter their commission structure. In another embodiment, the processor uses the AIP to make some or all of the determinations noted supra.

In one embodiment, the system determines compensation, or incentive, strategies, for example, a total compensation structure based on past performance of an employee to maximize the performance of that employee. In another embodiment, the system determines appropriate compensation based on upsell type, for example, easier upsells get less commission than hard upsells. Some upsells are easier for certain employee than others, and the compensation package is adjusted accordingly for a particular employee. In a further embodiment, the system determines appropriate compensation based on how an upsell is offered to customers, for example, hardware used, temporal parameters, or positional parameters, such as restaurant section. In another embodiment, the processor uses the AIP to make some or all of the determinations noted supra.

In one embodiment, the system determines an optimal commission package based on usage of a GUI and keystrokes. In another embodiment, the system determines compensation escalation and compensation thresholds, for example, how much to increase and when to increase a commission, or compensation, based on various transaction volume measurements. In a further embodiment, the system determines team compensation and team formation, for example, compensation for a team versus an individual employee. Considerations such as size of a team and composition of a team are considered, for example, one team for all staff, a day team, a night team, a counter team, or a drive through team, or combinations thereof. In one embodiment, the processor uses the AIP to make some or all of the determinations noted supra.

In one embodiment, the system determines value of compensation points, for example, whether many, low value points motivate an employee to work harder than few, higher value points. In another embodiment, the system, enables each employee to have their own points that get converted into common points periodically. In a further embodiment, the system determines employee recognition, for example, how to commend an employee, options such as with a noise from the POS, or with an email to the employee's boss prompting the boss to give a compliment are considered. In one embodiment, the processor uses the AIP to make some or all of the determinations noted supra.

In one embodiment, the system determines which actions by an employee are candidates for an incentive, for example, some tasks to do not get compensation while others do. In another embodiment, the system determines incentive based on operational parameters at a business locations, such as inventory levels. For example, upsells having items with high inventory receive adjusted commissions. In a further embodiment, the system determines compensation based on likelihood that a customer will accept upsell, for example, correlating historical data regarding types of customers with types of upsells and adjusting commissions accordingly. In one embodiment, the processor uses the AIP to make some or all of the determinations noted supra.

In general, incentives are offered to employees for the purpose of reaching one or more goals established by a business entity or entities employing the employees, or optimizing one or more parameters associated with operations of the preceding business entity or entities. That is, generating an incentive includes making a selection of one or more choices from among two or more choices that yields the best or optimized outcome or yields, including, but not limited to, optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices, or use of off peak or other coupons or acceptance of upsell or other marketing offers, or reduction or optimization of any customer or cashier or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results. In one embodiment, the processor uses the AIP to perform some or all of the determinations noted supra. In another embodiment, the discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the performance of the operations noted supra.

In one embodiment, the discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation of an incentive.

In one embodiment, memory element 304 stores historical information 340 regarding execution and results of a desired behavior. Information 340 can include histories for any or all of the considerations discussed supra, for example, historical acceptance rates for previously presented upsells, and historical performance of individual employees or groups or employees, such as compliance with presenting upsell offers or upsell success rates for an employee. The processor uses program 310 to modify the incentive according to information 340.

In one embodiment, memory element 304 stores historical information 341 regarding upsell offers, the historical data includes, but is not limited to: acceptance rates of previous upsell offers; or financial considerations, with respect to the first business entity, of previous upsell offers. Financial considerations can include any of the parameters or factors described supra or infra that impact the finances of the business entity, for example, check size, net or gross profit, or inventory reduction. For example, the data regarding financial considerations, with respect to the business entity, of previous upsell offers can include, but is not limited to, check size, net or gross profit, or inventory reduction associated with upsell offers previously available for presentation by the at least one employee, actually presented by the employee, or accepted by a customer. In another embodiment, the processor uses data 341 and the AIP to generate or modify the incentive.

In one embodiment, memory element 304 stores historical information 342 regarding the historical performance of offers, not included in upsells associated with an incentive made to the WCD. Such offers could include offers not made by the associated business entities. Alternately stated, information 342 tracks overall customer buying habits or tracks overall customer responses, including, accept rates or use of coupons and other suggestive selling or marketing offers, with respect to entities, such as the entity associated with location 314, or tracks individual customer buying habits or tracks customer responses, including, accept rates or use of coupons and other suggestive selling or marketing offers. The processor uses program 310 to generate or modify the incentive according to information 342. In another embodiment, the processor uses data 342 and the AIP to generate or modify the incentive.

In one embodiment, the memory stores data 344 regarding information searches previously performed using WCD 316A or by an end user of the WCD, and the processor modifies the incentive using the AIP and according to data 344. For example, the data could be regarding keyword searches performed using the WCD or by an end user of the WCD. Data 344 can be used to discern patterns or other aspects regarding the use of the WCD or activities of the end users that can be useful in optimizing pairings of upsells and incentives. The processor uses program 310 to generate or modify the incentive according to information 344. In another embodiment, the processor uses data 344 and the AIP to generate or modify the incentive. The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” regarding the modification of rules is applicable to the modification of the incentive by the processor.

As disclosed in commonly-owned U.S. patent application Ser. No. titled: “METHOD AND APPARATUS FOR GENERATING AND TRANSMITTING AN IDEAL ORDER OFFER,” inventors Otto et. al, filed Jul. 9, 2008, which application is incorporated by reference herein, in one embodiment, the processor reviews information 340 to identify an item or service not included in the history (an presumably never ordered by the customer) or ordered by the customer at less than a predetermined frequency. Then, the processor, using the AIP, optimizes pairings of upsells and incentives, for example, by including in an upsell an item or service not included in the information or ordered at less than a predetermined frequency. In another embodiment, this pairing is used to realize attainment of business and employee objectives.

In one embodiment, the processor, using the interface element, determines a location for WCD 316A using any means known in the art and uses the AIP and the location to optimize pairings of upsells and incentives. Commonly-owned U.S. patent application Ser. No. titled: “SYSTEM AND METHOD FOR LOCATION BASED SUGGESTIVE SELLING,” inventors Otto et al., filed Jul. 7, 2008 is applicable to location-based operations.

As disclosed in commonly-owned “METHOD AND APPARATUS FOR GENERATING AND TRANSMITTING AN IDEAL ORDER OFFER,” inventors Otto et. al, filed concurrently, in one embodiment, based upon the acceptance or rejection rates by a customer or customers of offers associated with upsells, the system determines the difficulty associated with accepting the upsell. If found to be difficult, e.g., due to a higher than average rejection rate system 300 can increase, using the AIP, the incentive associated with presenting the offers.

It should be understood that various storage and removal operations, not explicitly described above, involving memory 304 and as known in the art, are possible with respect to the operation of system 300. For example, outputs from and inputs to the general-purpose computer can be stored and retrieved from the memory elements and data generated by the processor can be stored in and retrieved from the memory.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007. It should be understood that system 300 can be integral with a computer operating system for a business location, for example, location 314 or with a business entity operating the business location. It also should be understood that system 300 can be wholly or partly separate from the computer operating system for a retail location, for example, location 314, or with a business entity operating the business location.

It should be understood that the AIPs and generic algorithms discussed infra can be a single AIP or a single generic algorithm, or can separate and individual AIPs and generic algorithms. Any combination of individual AIPs and generic algorithms is included in the spirit and scope of the claimed invention.

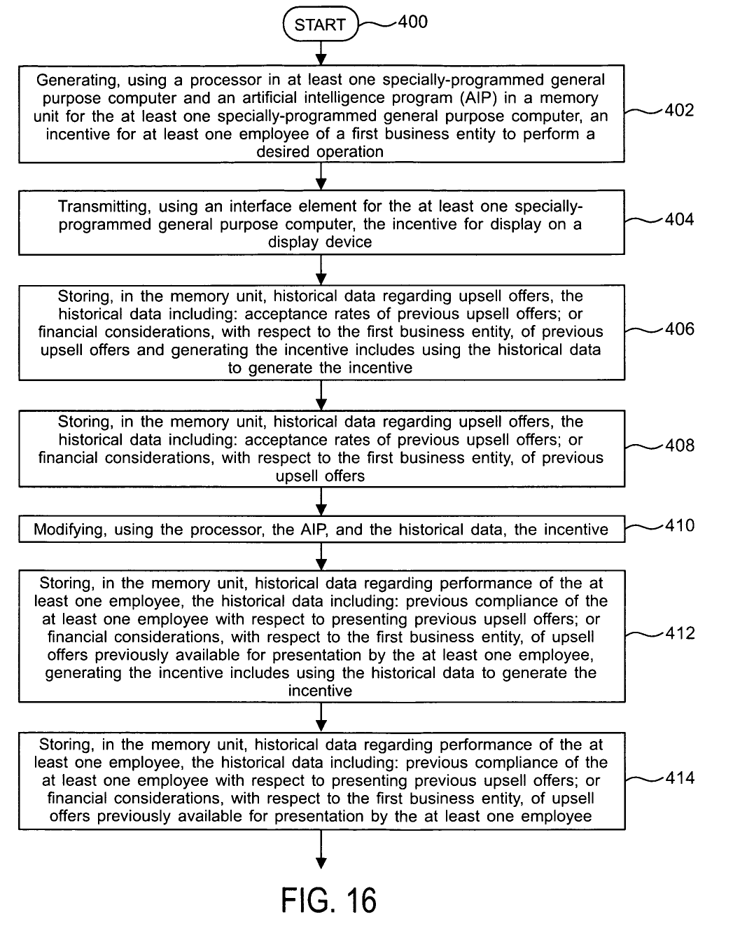

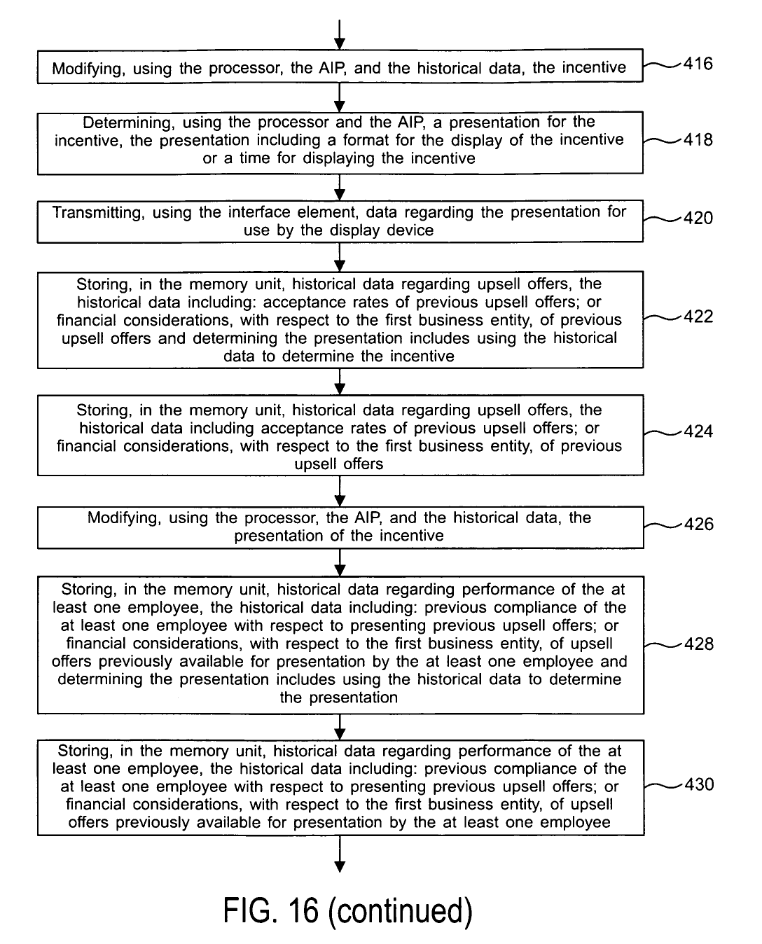

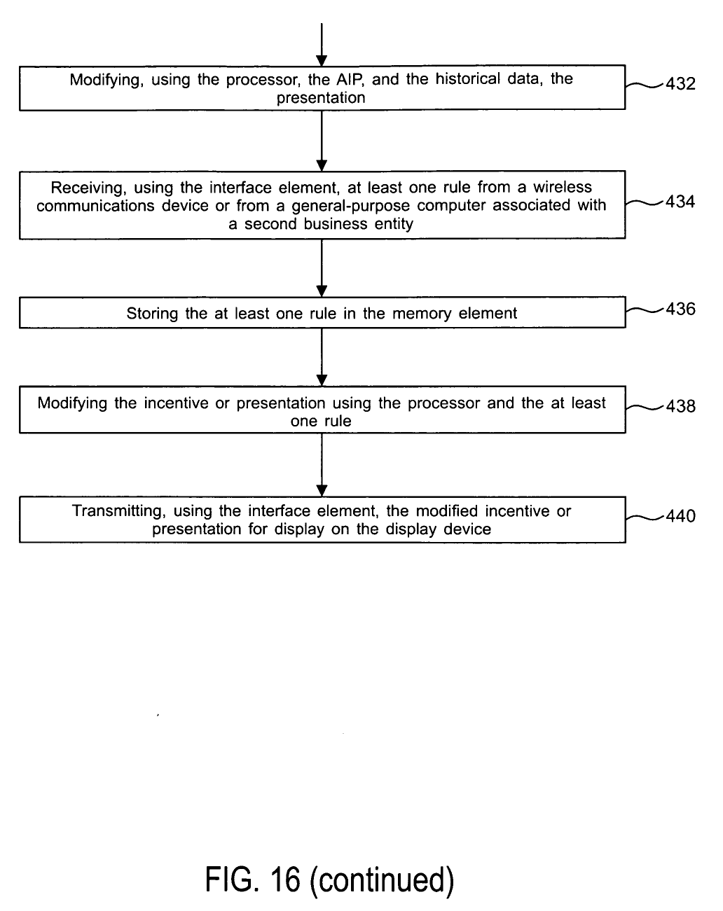

FIG. 16 is a flow chart illustrating a present invention computer-based method for providing an employee incentive. Although the method in FIG. 4 is depicted as a sequence of numbered steps for clarity, no order should be inferred from the numbering unless explicitly stated. The method starts at Step 400. Step 402 generates, using a processor in at least one specially-programmed general purpose computer and an artificial intelligence program (AIP) in a memory unit for the at least one specially-programmed general purpose computer, an incentive for at least one employee of a first business entity to perform a desired operation and step 404 transmits, using an interface element for the at least one specially-programmed general purpose computer, the incentive for display on a display device. In one embodiment, the desired operation includes presenting an upsell offer.

In one embodiment, step 406 stores, in the memory unit, historical data regarding upsell offers, the historical data including: acceptance rates of previous upsell offers; or financial considerations, with respect to the first business entity, of previous upsell offers and generating the incentive includes using the historical data to generate the incentive. In another embodiment, step 408 stores, in the memory unit, historical data regarding upsell offers, the historical data including: acceptance rates of previous upsell offers; or financial considerations, with respect to the first business entity, of previous upsell offers and step 410 modifies, using the processor, the AIP, and the historical data, the incentive. In a further embodiment, step 412 stores, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee, wherein generating the incentive includes using the historical data to generate the incentive.

In one embodiment, step 414 stores, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee and step 416 modifies, using the processor, the AIP, and the historical data, the incentive.

In one embodiment, step 418 determines, using the processor and the AIP, a presentation for the incentive, the presentation including a format for the display of the incentive or a time for displaying the incentive and step 420 transmits, using the interface element, data regarding the presentation for use by the display device. In another embodiment, step 422 stores, in the memory unit, historical data regarding upsell offers, the historical data including: acceptance rates of previous upsell offers; or financial considerations, with respect to the first business entity, of previous upsell offers and determining the presentation includes using the historical data to determine the incentive. In a further embodiment, step 424 stores, in the memory unit, historical data regarding upsell offers, the historical data including acceptance rates of previous upsell offers; or financial considerations, with respect to the first business entity, of previous upsell offers and step 426 modifies, using the processor, the AIP, and the historical data, the presentation of the incentive.

In one embodiment, step 428 stores, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee and determining the presentation includes using the historical data to determine the presentation. In another embodiment, step 430 stores, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee and step 432 modifies, using the processor, the AIP, and the historical data, the presentation.

In one embodiment, step 434 receives, using the interface element, at least one rule from a wireless communications device or from a general-purpose computer associated with a second business entity; step 436 stores the at least one rule in the memory element; step 438 modifies the incentive or the presentation using the processor and the at least one rule; and step 440 transmits using the interface element, the modified incentive or presentation for display on the display device. In another embodiment, the first and second business entities are the same.

The following should be viewed in light of FIGS. 1 through 16. In one embodiment, for any or all of those instances of a present invention system or method in which an artificial intelligence program or generic algorithm is used, a rule or set of rules (not shown) is used in conjunction with the artificial intelligence program or generic algorithm. For example, in the preceeding embodiment, the processor uses data 344, the AIP, and a rule or set of rules (not shown) stored in the memory element to generate or modify the incentive. The operation of an artificial intelligence program or generic algorithm with a rule or set of rules is described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to generate or modify a desired transaction or incentive, with respect to determine an incentive for motivating a desired behavior by an employee. The present invention can use any, all, or none of the following considerations as part of determining an incentive for motivating a desired behavior by an employee, for example, by adding programming logic, self-learning, and self-adaptation as noted supra:
1. One or more business, customer or sponsor objectives.
2. Temporal parameters, such as, time of day, day of week, month, or year.
3. Any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, current speed of service, quality of service or other operating data, budgets, objectives or trends, etc.

In one embodiment, the present invention employs any, all, or none of the following considerations as part of generating or modifying incentives or presentation of incentives, for example, by adding programming logic, self-learning, and self-adaptation as noted supra:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other Al based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In one embodiment, marketing messages, content, offers, incentives, etc., are created or maintained centrally or in a distributed network, including, for example, locally. Such management may be accomplished via any applicable means available, including, for example, making use of existing, e.g., off the shelf or customized tools that provide for such creating, management or distribution.

In another embodiment, in an effort to further enhance generating or modifying incentives or presentation of incentives, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, each location associated with the present invention establishes its own rules, uses its own AIP or generic algorithm, or learns from local employee or customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to generate and modify incentives and presentation of incentives. For example, when using an Al based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of incentive or presentation is particularly effective. By sharing such information among other locations, for example, similar locations, the present invention can begin to make use of the same or similar incentives, offers or benefits in other generally similar locations or with other similar employees, types of employees, customers, or classifications of customers so as to improve the performance of one or more other such locations or all locations. In this fashion, the present invention can learn which incentives and presentation of incentives more quickly or generally achieve the desired results or improve trends towards such results. Likewise, the present invention can more quickly determine which incentives or presentations do not yield the desired results or determine how long such offers, incentives or benefits are required to achieve the desired results.

In a further embodiment, incentives are provided or subsidized by one or more third parties, including, for example, third party sponsors. For example, a vendor supplying an item in an upsell offer could subsidize an incentive to encourage acceptance of the item. In another example, such an offer may be partially or fully subsidized by an unrelated third party sponsor. For example, as part of an upsell, a telecommunications company offers to view an advertisement for telecommunications company or fill out a survey or perform some other action or accept a subsequent or related optional or required offer, etc.

The following U.S. patent applications are applicable to an upsell offer: U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151/043, titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; commonly-owned U.S. patent application Ser. No. 12/151,038, titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008; commonly-owned U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. entitled “SYSTEM AND METHOD FOR PROVIDING INCENTIVES TO AN END USER FOR REFERRING ANOTHER END USER”, inventors Otto et al., filed Jul. 9, 2008; commonly-owned U.S. patent application Ser. No. entitled “METHOD AND SYSTEM FOR GENERATING A REAL TIME OFFER OR A DEFERRED OFFER”, inventors Otto et al., filed Jul. 9, 2008; commonly-owned U.S. patent application Ser. No. entitled “METHOD AND APPARATUS FOR GENERATING AND TRANSMITTING AN IDEAL ORDER OFFER”, inventors Otto et al., filed Jul. 9, 2008; commonly-owned U.S. patent application Ser. No. entitled “SYSTEM AND METHOD FOR GENERATING AND TRANSMITTING LOCATION BASED PROMOTIONAL OFFER REMINDERS”, inventors Otto et al., filed Jul. 9, 2008; commonly-owned U.S. patent application Ser. No. entitled “SYSTEM AND METHOD FOR LOCATION BASED SUGGESTIVE SELLING”, filed Jul. 9, 2008; and commonly-owned U.S. patent application entitled “SYSTEM AND METHOD FOR SCANNING A COUPON TO INITIATE AN ORDER”, filed May 2, 2008.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware:

Central Controller or Local Controllers. The present invention can be managed by a central system on behalf of multiple business entities or locations or systems associated with portions of the multiple business entities or locations can implement the present invention.

Retailer System 1-n

Point of Sale Device 1-n

2. Software:

Incentive Program-manages incentives for cashiers, for example, determining commissions or rewards to include in incentives.

Incentive Presentation Program-manages presentation of incentives.

Incentive Adjustment Program-adjusts incentives and presentation of incentives, for example, based on feedback or other performance data.

The following is a listing of exemplary data bases that can be used in a present invention method or system. It should be understood that a present invention method or system is not limited to any or all of the databases shown and that other databases are included in the spirit and scope of the claimed invention.

Employee Database-stores employee data

Employee class Database-stores classification data for employees

Display Database-stores display information

Transaction Database-stores transaction data including incentive data for transactions

Customer Database-stores data about customers

Customer Type Database-stores data about customer types

Customer Type Incentive Rules Database-stores rules for incentives based on customer type

POS Database-stores POS data

Team Database-stores Employee team data

Team score Database-stores information about scoring teams

Incentive score Database-stores information about incentive scores

Incentive Type Database-stores information about incentive types

Incentive Database-stores information about available incentives

Incentive Display Database-stores information about how to display incentives

Incentive Recognition Database-stores information about different types of Employee recognition

Incentive Value Database-stores information about the monetary value of incentives

Incentive Value Multiplier Database-stores information about value multipliers to apply to incentives when they are redeemed

Incentive Thresholds Database-stores information about thresholds that Employees can achieve to receive incentive adjustments

Compensation Strategy Database-stores information about strategies to create total compensation packages for Employees

Compensation Score Database-stores information about scores for compensation packages

Incentive Goals Database-stores goals that can be achieved to adjust incentives GUI Database-stores information for layouts of POS screens that including compensation displays

GUI Usage Database-stores the usage of POS screen layouts

Display Database-stores the available displays in a retail establishment

Upsell Database-stores the upsells available to offer in a POS transaction

Upsell Type Database-stores the types of upsells available to offer in a POS transaction

Upsell Score Database-stores the scores for upsells

Prompt Database-stores prompts available

Task Database Database-stores tasks available

Task Incentive Database-stores incentives due when tasks are performed

Task Rules Database-stores rules governing when to offer prompts to conduct tasks

Task Prompt Database-stores the prompts made on a POS when tasks need to be done

Task Prompt Rules Database-stores the rules for offering prompts to conduct tasks

Task Score Database-stores scores for tasks as they relate incentives

Inventory Database-stores inventory amounts at a retailer

Inventory incentive Rules Database-stores incentives for selling items in inventory

Alerts Database-stores alerts to output to maximize incentives

Alerts Rules database-store rules for outputting alerts to maximize incentives

Some embodiments of the methods and systems described above were described in the context of being used by cashiers and sales clerks. These and other embodiments of the invention may also be adapted for use by other types of employees. For example, the disclosed methods and systems could be adapted to motivate a call center operator to perform behaviors related to upselling products to the customers who are being called or who are calling into the call center. For example, when a telephone customer who desires to order basic telephone service makes a call into a call center for a telephone company, a central computer for that call center could be configured to determine information about an upsell to the basic telephone service (e.g., “caller I.D. service” for an extra $1.95 per month), to determine a compensation associated with the upsell (e.g., an extra compensation of $1.00 for offering the caller I.D. service as an upsell, and an extra $2.00 if the customer signs up for that service), and to output information about the compensation to the operator who is assisting that customer (e.g., by providing a message on a computer screen being used by the operator that, “If you offer ‘caller I.D. service’ to the customer, you'll earn an additional $1.00. If the customer accepts, you'll earn an additional $2.00.”). The embodiments of the methods and systems disclosed above can also be employed in this call-center environment, as well as in other environments such as Internet-based ordering systems where employees can be motivated to perform behaviors related to upsells by providing compensation.

It is to be understood that the embodiments and variations shown and described herein are merely illustrative of the principles of this invention and that various modifications may be implemented by those skilled in the art without departing from the scope and the spirit of the invention. For example, while the invention has been illustrated as being implemented using particular computer systems including hardware components such as a computer, POS terminals, portable employee terminals, and input and output devices, the invention could also be implemented using other hardware components and/or other interconnections between such components. Also, while the invention has been described as being implemented using a computer, some or all of the functionality could alternatively reside in a POS terminal or other computing device (e.g., a headset). The invention could also be implemented using discrete hardwired components instead of computers. Further, while the above description refers to particular databases, other databases or data structures could be used. In addition, while various embodiments of methods in accordance with the invention have been discussed which include specific steps listed in specific orders, a person of skill in the art will recognize that these steps can be performed in different combinations and orders. Multiple incentives, or compensation offers, can be made to an employee for performing multiple behaviors within a single transaction, or for performing a series of behaviors during a series of transactions. The disclosed methods and systems could also be applied to motivating employees to perform behaviors other than those relating to upsells, such as behaviors associated with completing a sale, greeting a customer, performing a maintenance task, or making a delivery. While other modifications will be evident to those skilled in the art, the present invention is intended to extend to those modifications that nevertheless fall within the scope of the appended claims.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for providing an incentive for an employee, comprising:
generating, using a processor in at least one specially-programmed general purpose computer and an artificial intelligence program (AIP) in a memory unit for the at least one specially-programmed general purpose computer, an incentive for at least one employee of a first business entity to perform a desired operation; and,
transmitting, using an interface element for the at least one specially-programmed general purpose computer, the incentive for display on a display device.

2. The method of claim 1 wherein the desired operation includes presenting an upsell offer.

3. The method of claim 2 further comprising storing, in the memory unit, historical data regarding upsell offers, the historical data including: acceptance rates of previous upsell offers; or financial considerations, with respect to the first business entity, of previous upsell offers and wherein generating the incentive includes using the historical data to generate the incentive.

4. The method of claim 2 further comprising:
storing, in the memory unit, historical data regarding upsell offers, the historical data including acceptance rates of previous upsell offers or financial considerations, with respect to the first business entity, of previous upsell offers; and,
modifying, using the processor, the AIP, and the historical data, the incentive.

5. The method of claim 2 further comprising storing, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee, wherein generating the incentive includes using the historical data to generate the incentive.

6. The method of claim 2 further comprising:
storing, in the memory unit, historical data regarding performance of the at least one employee, the historical data including: previous compliance of the at least one employee with respect to presenting previous upsell offer; or financial considerations, with respect to the first business entity, of upsell offers previously available for presentation by the at least one employee; and,
modifying, using the processor, the AIP, and the historical data, the incentive.

7. The method of claim 1 further comprising:
determining, using the processor and the AIP, a presentation for the incentive, the presentation including a format for the display of the incentive or a time for displaying the incentive; and,
transmitting, using the interface element, data regarding the presentation for use by the display device.

8. The method of claim 7 further comprising storing, in the memory unit, historical data regarding upsell offers, the historical data including: acceptance rates of previous upsell offers; or financial considerations, with respect to the first business entity, of previous upsell offers and wherein determining the presentation includes using the historical data to determine the incentive.

9. The method of claim 7 further comprising:
storing, in the memory unit, historical data regarding upsell offers, the historical data including: acceptance rates of previous upsell offers; or financial considerations, with respect to the first business entity, of previous upsell offers; and,
modifying, using the processor, the AIP, and the historical data, the presentation of the incentive.

10. The method of claim 7 further comprising storing, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee, wherein determining the presentation includes using the historical data to determine the presentation.

11. The method of claim 7 further comprising:
storing, in the memory unit, historical data regarding performance of the at least one employee, the historical data including: previous compliance of the at least one employee with respect to presenting previous upsell offers; or financial considerations, with respect to the first business entity, of upsell offers previously available for presentation by the at least one employee; and,
modifying, using the processor, the AIP, and the historical data, the presentation.

12. The method of claim 7 further comprising the steps of:
receiving, using the interface element, at least one rule from a wireless communications device or from a general-purpose computer associated with a second business entity;
storing the at least one rule in the memory element;
modifying the presentation using the processor and the at least one rule; and,
transmitting, using the interface element, the modified presentation for display on the display device.

13. The method of claim 12 wherein the first and second business entities are the same.

14. The method of claim 1 further comprising the steps of:
receiving, using the interface element, at least one rule from a wireless communications device or from a general-purpose computer associated with a second business entity;
storing the at least one rule in the memory element;
modifying the incentive using the processor and the at least one rule; and,
transmitting, using the interface element, the modified incentive for display on the display device.

15. The method of claim 12 wherein the first and second business entities are the same.

16. A system for providing an employee incentive, comprising:
an interface element for at least one specially programmed general-purpose computer;
a memory unit for the at least one specially programmed general-purpose computer; and,
a processor for the at least one specially programmed general-purpose computer for:
generating, using an artificial intelligence program (AIP) in the memory unit, an incentive for at least one employee of a first business entity to perform at least one desired operation; and,
transmitting, using the interface element, the incentive for display on a display device.

17. The system of claim 16 wherein the desired operation includes presenting an upsell offer.

18. The system of claim 17 wherein the memory unit stores historical data regarding upsell offers, the historical data including: acceptance rates of previous upsell offers; or financial considerations, with respect to the first business entity, of previous upsell offers and wherein the processor is for generating the incentive using the historical data.

19. The system of claim 17 wherein the memory unit is for storing historical data regarding upsell offers, the historical data including: acceptance rates of previous upsell offers; or financial considerations, with respect to the first business entity, of previous upsell offers and wherein the processor is for modifying, using the AIP and the historical data, the incentive.

20. The system of claim 17 wherein the memory unit stores historical data regarding performance of the at least one employee, the historical data including: previous compliance of the at least one employee with respect to presenting previous upsell offers; or financial considerations, with respect to the first business entity, of upsell offers previously available for presentation by the at least one employee, and wherein the processor is for generating the incentive using the historical data.

21. The system of claim 17 wherein the memory unit is for storing historical data regarding performance of the at least one employee, the historical data including: previous compliance of the at least one employee with respect to presenting previous upsell offers; or financial considerations, with respect to the first business entity, of upsell offers previously available for presentation by the at least one employee and wherein the processor is for modifying, using the AIP and the historical data, the incentive.

22. The system of claim 16 wherein the processor is for: determining, using the AIP, a presentation for the incentive, the presentation including a format for the display of the incentive or a time for displaying the incentive and wherein the processor is for transmitting, using the interface element, data regarding the presentation for use by the display device.

23. The system of claim 22 wherein the memory unit is for storing historical data regarding upsell offers, the historical data including: acceptance rates of previous upsell offers; or financial considerations, with respect to the first business entity, of previous upsell offers and wherein the processor is for determining the presentation using the historical data.

24. The system of claim 22 wherein the memory unit is for storing historical data regarding upsell offers, the historical data including: acceptance rates of previous upsell offers; or financial considerations, with respect to the first business entity, of previous upsell offers and wherein the processor is for modifying, using the AIP and the historical data, the presentation of the incentive.

25. The system of claim 22 wherein the memory unit is for storing historical data regarding performance of the at least one employee, the historical data including: previous compliance of the at least one employee with respect to presenting previous upsell offers; or financial considerations, with respect to the first business entity, of upsell offers previously available for presentation by the at least one employee and wherein the processor is for determining the presentation using the historical data.

26. The system of claim 22 wherein the memory unit stores historical data regarding performance of the at least one employee, the historical data including previous compliance of the at least one employee with respect to presenting previous upsell offers; or financial considerations, with respect to the first business entity, of upsell offers previously available for presentation by the at least one employee and wherein the processor is for modifying, using the AIP and the historical data, the presentation.

27. The system of claim 22 wherein the processor is for:
receiving, using the interface element, at least one rule from a wireless communications device or from a general-purpose computer associated with a second business entity;
storing the at least one rule in the memory element;
modifying the presentation using the processor and the at least one rule; and,
transmitting, using the interface element, the modified presentation for display on the display device.

28. The system of claim 27 wherein the first and second business entities are the same.

29. The system of claim 16 wherein the processor is for:
receiving, using the interface element, at least one rule from a wireless communications device or from a general-purpose computer associated with a second business entity;
storing the at least one rule in the memory element;
modifying the incentive using the processor and the at least one rule; and,
transmitting, using the interface element, the modified incentive for display on the display device.

30. The system of claim 29 wherein the first and second business entities are the same.
